(19) United States
(12) Patent Application Publication
(10) Pub. No.: US 2007/0263523 A1
(43) Pub. Date: Nov. 15, 2007

(54) Objective lens optical system and optical pickup optical system

(75) Inventor: Yasuyuki Sugi, Ibaraki-shi (JP)

Correspondence Address: OLIFF & BERRIDGE, PLC, P.O. BOX 19928, ALEXANDRIA, VA, 22320, US

(73) Assignee: HITACHI MAXELL, LTD., IBARAKI-SHI (JP)

(21) Appl. No.: 11/797,481

(22) Filed: May 3, 2007

(30) Foreign Application Priority Data
May 12, 2006 (JP) 2006-134311

(51) Int. Cl. G11B 7/00

(52) U.S. Cl. 369/112.23

(57) ABSTRACT

The present invention aims at focusing a light beam on each of a plurality of kinds of optical recording media having different thicknesses of transparent substrates with a suitable wave-optic optical spot shape. In an objective lens optical system according to the present invention, at least one surface of an aberration correction plate is sectioned into five or more zones, including a first zone closest to an optical axis serving as a common zone, and four or more zones as a second and subsequent zones respectively having a lens surface shape corresponding to the thickness of each transparent substrate.

### BACKGROUND OF THE INVENTION

1. Field of the Invention

The present invention relates to an objective lens optical system or an optical pickup optical system capable of recording or reproducing a plurality of kinds of media with different thickness. Particularly, the present invention relates to a general lens, optical element, optical system, optical head, and optical disc apparatus which can be used for a recording and playback device that is compatible with different kinds of optical recording media such as a CD (Compact Disc, including CD-R or the like), a DVD (Digital Versatile Disc), a Blu-ray Disc and an HDDVD.

2. Description of Related Art

Compatible optical disc apparatus that is capable of playing back different kinds of optical discs such as a CD and a DVD have been proposed. A CD and DVD (which are referred hereinafter as optical discs) are both composed of a transparent substrate, one face of which has an information recording surface. An optical disc has the structure that such two transparent substrates are adhered to each other with the information recording surfaces facing each other, or such a transparent substrate and a transparent protective substrate are adhered to each other with the information recording surface of the transparent substrate facing the protective substrate.

In order to play back an information signal which is stored in an optical disc having such a structure, it is necessary to focus a laser beam from a light source on an information recording surface of the optical disc through a transparent substrate using an optical disc apparatus. When playing back a CD, a laser beam with a wavelength of about 780 nm and an objective lens with a numerical aperture NA of 0.45 to 0.53 are used. When playing back a DVD, a laser beam with a wavelength of about 650 nm and an objective lens with a numerical aperture NA of 0.60 to 0.67 are used. The thickness of a transparent substrate which is used in a CD is 1.2 mm, and the thickness of a transparent substrate which is used in a DVD is 0.6 mm. The thickness of a transparent substrate having an information recording surface thus differs with the kind of optical discs (which is a difference in the wavelength of a laser beam). A compatible optical disc apparatus which plays back different kinds of optical discs needs to focus a laser beam on an information recording surface even if the thickness of a transparent substrate differs with the kind of optical discs.

Such a compatible optical disc apparatus may have a plurality of objective lenses corresponding to the kinds of optical discs in a pickup and change the objective lenses according to the kind of an optical disc in use, or have a plurality of pickups corresponding to the kinds of optical discs and change the pickups according to the kind of an optical disc in use. However, for cost and size reduction of an apparatus, it is preferred to use the same objective lens for any kinds of optical discs.

A typical example of such an objective lens is disclosed in Japanese Unexamined Patent Application Publication No. 9-145995. The objective lens that is described in this document is sectioned into three or more loop zonal lens surfaces in the radial direction, and one set of every other loop zonal lens surfaces and another set of every other zonal lens surfaces have different refractive powers. One set of every other loop zonal lens surfaces focuses a laser beam with a certain wavelength on an information recording surface of an optical disc (DVD) having a thin transparent substrate (0.6 mm), for example, and another set of every other zonal lens surfaces focuses a laser beam with the same wavelength on an information recording surface of an optical disc (CD) having a thick transparent substrate (1.2 mm), for example.

Another typical example is disclosed in Japanese Unexamined Patent Application Publication No. 2000-81566. This document discloses an optical disc apparatus which uses a laser beam with a short wavelength (635 nm or 650 nm) for a DVD having a thin transparent substrate and uses a laser beam with a long wavelength (780 nm) for a CD having a thick transparent substrate. The optical disc apparatus includes an objective lens which is used in common for those laser beams. The objective lens has a diffractive lens structure in which fine loop zonal steps are formed in close proximity to each other on one surface of a refractive lens having a positive power. Such a diffractive lens structure is designed to focus diffracted light of a laser beam with a short wavelength on an information recording surface of a DVD having a thin transparent substrate and to focus diffracted light of a laser beam with a long wavelength on an information recording surface of a CD having a thick transparent substrate. It is designed to focus the diffracted light of the same order on each information recording surface. A laser beam with a short wavelength is used for a DVD because the recording density of a DVD is higher than that of a CD and it is therefore necessary to narrow a beam spot. As well known, the size of an optical spot is proportional to a wavelength and is inversely proportional to a numerical aperture NA.

Another typical example is disclosed in Japanese Unexamined Patent Application Publication No. 7-302437. This document discloses an objective lens of an optical disc apparatus which uses a laser beam with a short wavelength (680 nm) for a thin transparent substrate of 0.6 mm and uses a laser beam with a long wavelength (780 nm) for a thick transparent substrate of 1.2 mm. In the objective lens, a lens surface is sectioned into a plurality of ring regions, and one region focuses light with one wavelength on an optical disc having one substrate thickness.

A new optical disc apparatus which has been proposed recently uses blue laser with a wavelength of about 450 nm for a Blu-ray Disc and an HDDVD in order to increase the recording density. When playing back a Blu-ray Disc, a laser beam with a wavelength of 405 to 408 nm and an objective lens with NA of 0.85 are used. The thickness of a transparent substrate of a Blu-ray Disc is 0.075 to 0.1 mm for both a dual-layer optical disc and a single-layer optical disc. When playing back an HDDVD, a laser beam with a wavelength of 405 to 408 nm and an objective lens with NA of 0.65 are used. The thickness of a transparent substrate of an HDDVD is 0.6 mm. These values include the error range which is specified in the standards or the like. There is thus a demand for an apparatus which is compatible with the two kinds of optical discs, a Blu-ray Disc and an HDDVD, in one system.

Although Japanese Unexamined Patent Application Publication No. 9-145995 includes a description regarding a DVD and a CD, it does not include a description about a Blu-ray Disc, an HDDVD or the like. Because the wavefront aberration for the same ray aberration (mm) increases in inverse proportion to a wavelength when the wavelength of a laser which is used is short, and the third order spherical aberration increases in proportion to the fourth power of NA when NA is large, aberration correction becomes more difficult. It is thus difficult for the technique disclosed in Japanese Unexamined Patent Application Publication No. 9-145995 to obtain a desired shape of an optical spot by focusing light using the same objective lens, objective lens optical system or optical pickup optical system for a Blu-ray Disc and an HDDVD having a different wavelength and NA from a DVD and a CD, which are a Blu-ray and an HDDVD that require a shorter wavelength and a larger NA than a DVD and a CD that are described in Japanese Unexamined Patent Application Publication No. 9-145995.

Further, because Japanese Unexamined Patent Application Publication No. 2000-81566 uses diffracted light in the diffractive lens structure, it is impossible to deal with transparent substrates with different thicknesses without using light beams with different wavelengths. Accordingly, the technique of Japanese Unexamined Patent Application Publication No. 2000-81566 cannot be used if the thickness of a transparent substrate is different and the wavelength is the same or substantially the same.

An object of the present invention is to solve the above problems and provide an optical element capable of focusing a light beam on an information recording surface on each of a plurality of kinds of optical information recording media with a good wave-optic optical spot shape, and an optical system, an optical head, and an optical disc apparatus using the optical element. More particularly, an object of the present invention is to provide an optical element compatible with two different specifications of information recording media where the thickness of information recording media and NA of an objective lens are different and capable of focusing each light beam on an information recording surface with a good wave-optic optical spot shape using the same wavelength light, and an optical system, an optical head, and an optical disc apparatus using the optical element.

### SUMMARY

According to the present invention, there is provided an objective lens optical system for focusing a light beam on each information recording surface on at least two different thicknesses of transparent substrates in two or more kinds of optical information recording media, wherein at least one surface of two surfaces constituting an optical element is radially sectioned into five or more zones, at least one zone of the five or more zones is a common zone for focusing the light beam on each information recording surface of the two or more kinds of optical information recording media, and at least four zones of the five or more zones are exclusive zones for focusing the light beam on an information recording surface of either one optical information recording medium of the two or more kinds of optical information recording media.

The objective lens optical system preferably includes an objective lens and an aberration correction plate. More preferably, it includes a glass objective lens and a plastic aberration correction plate.

The light beam preferably includes a light beam with a wavelength of about 405 nm. More preferably, it includes a light beam of NA 0.8 to NA 0.9.

The light beam focused on the information recording surface on at least two different thicknesses of transparent substrates is preferably NA=0.60 or larger.

The light beam focused on the information recording surface on at least two different thicknesses of transparent substrates preferably includes a light beam of NA=0.8 to NA=0.9 and a light beam of NA=0.6 to NA=0.7.

Preferably, an average of a side lobe in each optical recording medium on an optical spot of the light beam focused on the information recording surface on the optical information recording media is 2% or smaller. More preferably, an average of a side lobe in each optical recording medium is 1.7% or smaller.

It is preferred that both of a light beam passing through the exclusive zone and a light beam passing through the common zone are focused on an information recording surface of a corresponding optical information recording medium with wavefront aberration of 0 or larger or wavefront aberration of 0 or smaller.

It is also preferred that both of a light beam passing through the exclusive zone and a light beam passing through the common zone are focused on an information recording surface of a corresponding optical information recording medium with wavefront aberration of 0 to 0.4λ or wavefront aberration of −0.4λ to 0.

According to another aspect of the present invention, there is provided an objective lens optical system for focusing a light beam with a wavelength λ on each information recording surface on a first optical information recording medium having a transparent substrate with a thickness t₁ and a second optical information recording medium having a transparent substrate with a thickness t₂, the objective lens optical system including an objective lens and an aberration correction plate, wherein the objective lens is configured to focus the light beam on an information recording surface on the transparent substrate with the thickness t₁ of the first optical information recording medium with aberration being corrected suitably, at least one surface of the aberration correction plate is radially sectioned into five or more zones, at least one zone of the five or more zones is a common zone for focusing the light beam on each information recording surfaces of both the first optical information recording medium and the second optical information recording medium, and at least four zones of the five or more zones are exclusive zones for focusing the light beam on an information recording surface of either one optical information recording medium of the first optical information recording medium and the second optical information recording medium.

It is preferred that both of a light beam passing through the exclusive zone and a light beam passing through the common zone are focused on an information recording surface of a corresponding optical information recording medium with wavefront aberration of 0 to 0.4λ or wavefront aberration of −0.4λ to 0.

According to the present invention, there is provided an optical pickup optical system for focusing a light beam on each information recording surface on at least two different thicknesses of transparent substrates in two or more kinds of optical information recording media, wherein at least one surface of two surfaces constituting an optical element is radially sectioned into five or more zones, at least one zone of the five or more zones is a common zone for focusing the light beam on each information recording surface of the two or more kinds of optical information recording media, and at least four zones of the five or more zones are exclusive zones for focusing the light beam on an information recording surface of either one optical information recording medium of the two or more kinds of optical information recording media.

As described above, the present invention provides an objective lens optical system and an optical pickup optical system capable of focusing a light beam on an information recording surface on each of a plurality of kinds of optical information recording media with a good wave-optic optical spot shape.

### BRIEF DESCRIPTION OF THE DRAWINGS

The above and other objects, advantages and features of the present invention will be more apparent from the following description of certain preferred embodiments taken in conjunction with the accompanying drawings, in which:

FIG. 1 shows a view of an optical system of a Blu-ray exclusive objective lens 1;

FIG. 2 shows a view of an HDDVD optical system composed of the Blu-ray exclusive objective lens 1 and an aberration correction plate 2;

FIG. 3 shows wavefront aberration charts in the optical system shown in FIG. 22 where the thickness of a cover glass is 0.6 mm;

FIG. 4 shows wavefront aberration charts in the optical system shown in FIG. 22 where the thickness of a cover glass is 0.0875 mm;

FIG. 5 shows wavefront aberration charts in a first embodiment where the thickness of a cover glass is 0.6 mm;

FIG. 6 shows wavefront aberration charts in the first embodiment where the thickness of a cover glass is 0.0875 mm;

FIG. 7 shows optical spot charts for an HDDVD in the first embodiment;

FIG. 8 shows optical spot charts for a Blu-ray Disc in the first embodiment;

FIG. 9 shows optical spot charts for an HDDVD in a second embodiment;

FIG. 10 shows optical spot charts for a Blu-ray Disc in the second embodiment;

FIG. 11 shows optical spot charts for an HDDVD in the optical system shown in FIG. 22;

FIG. 12 shows optical spot charts for a Blu-ray Disc in the optical system shown in FIG. 22;

FIG. 13 shows optical spot charts in an HDDVD optical system;

FIG. 14 shows optical spot charts in a Blu-ray exclusive lens;

FIG. 15 shows arrangement plans of an optical system in the first embodiment of the present invention;

FIG. 16 shows wavefront aberration charts in the second embodiment where the thickness of a cover glass is 0.6 mm;

FIG. 17 shows wavefront aberration charts in the second embodiment where the thickness of a cover glass is 0.0875 mm;

FIG. 18 shows tables regarding lens arrangement and aspherical coefficients of a Blu-ray exclusive lens;

FIG. 19 shows a table regarding wavefront aberration, angle of view, and image height characteristics of an objective lens;

FIG. 20 shows tables regarding lens arrangement and aspherical coefficients of an HDDVD optical system that includes an aberration correction plate and an objective lens;

FIG. 21 shows a table regarding wavefront aberration, angle of view, and image height characteristics of the HDDVD optical system shown in FIG. 20;

FIG. 22 shows tables regarding lens arrangement and aspherical coefficients of a comparative example that includes an aberration correction plate and an objective lens;

FIG. 23 shows tables regarding lens arrangement and aspherical coefficients of an optical system that includes an aberration correction plate and an objective lens according to the first embodiment;

FIG. 24 shows tables regarding lens arrangement and aspherical coefficients of an optical system that includes an aberration correction plate and an objective lens according to the second embodiment;

FIG. 25 shows a table summarizing side lobe values; and

FIG. 26 shows a table summarizing optical spot diameters (in the range with a relative light intensity of 13.5% or higher).

### DETAILED DESCRIPTION OF THE PREFERRED EMBODIMENTS

Assume that a first optical disc which includes a transparent substrate with a thickness of t₁ is attached to an optical disc apparatus, and a laser beam having a wavelength of λ is suitably focused through an objective lens on an information recording surface of the transparent substrate with aberration being properly corrected. In this case, if a second optical disc which includes a transparent substrate with a thickness of t₂ is attached to the optical disc apparatus, the laser beam having a wavelength of λ is not suitably focused on an information recording surface due to a difference in the thickness of a transparent substrate.

In the present invention, a lens surface area which is outside of a lens surface area that is the closest to a lens optical axis and includes the lens optical axis is sectioned into lens surface regions respectively used for different optical discs having different thickness of transparent substrates so that there are at least four exclusive zones with optimum lens surface shapes, thereby forming a good wave-optic optical spot shape with low side lobe for each of different thickness of optical discs.

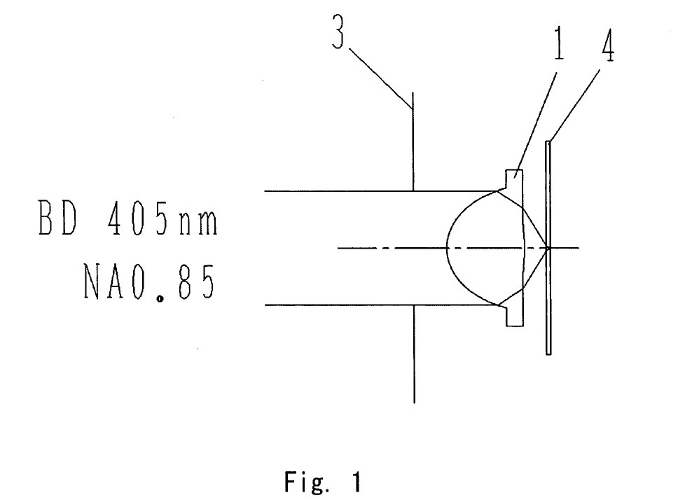

Prior to describing an objective lens optical system according to the present invention, a Blu-ray exclusive objective lens is described hereinafter. The lens surface shape of a Blu-ray exclusive lens 1 shown in FIG. 1 is designed so that wavefront aberration is minimum for a Blu-ray Disc. Specifically, the lens surface shape of the objective lens 1 is designed so that wavefront aberration is minimized for a dual-layer Blu-ray Disc having a substrate thickness of 0.0875 mm, which is intermediate between substrate thicknesses of 0.075 mm and 0.1 mm. When recording or playing back an actual Blu-ray Disc, an aberration correction element (not shown), which is mounted separately, is used to enable the recording or playback of a Blu-ray Disc with a substrate thickness of 0.100 mm or 0.075 mm. Thus, the objective lens 1 is designed to be suited for a substrate thickness of 0.0875 mm, which is a center value of the thickness of a Blu-ray Disc, and an aberration correction element which is mounted separately, such as a beam expander, is used to make appropriate correction for each Blu-ray Disc so as to be suited for an actual substrate thickness. The aberration correction element which is mounted separately is such that it can correct aberration if a difference in substrate thickness is within several tens of μm but cannot correct aberration if a difference in substrate thickness is as large as 0.5125 mm, which is a difference between 0.875 mm that is a center thickness of a Blu-ray Disc and 0.6 mm that is a thickness of an HDDVD, for example.

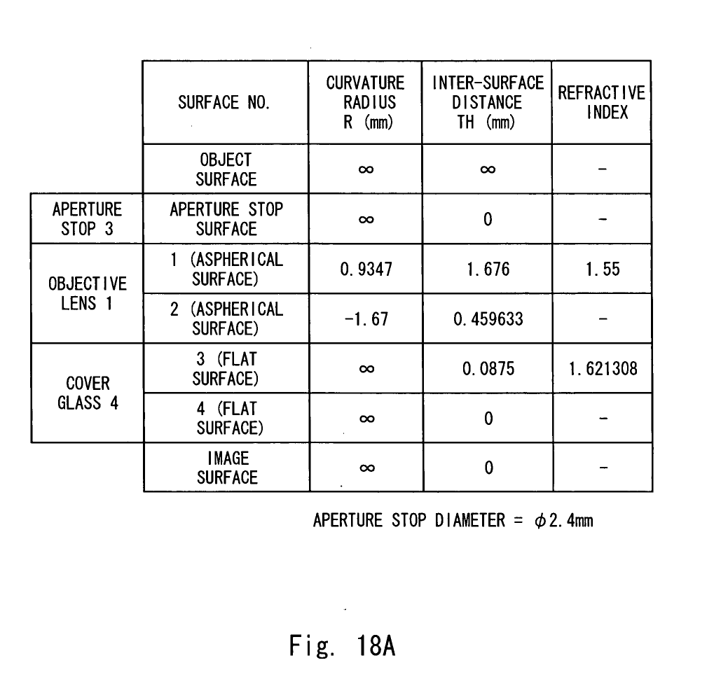

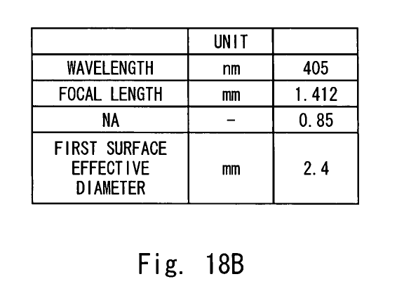

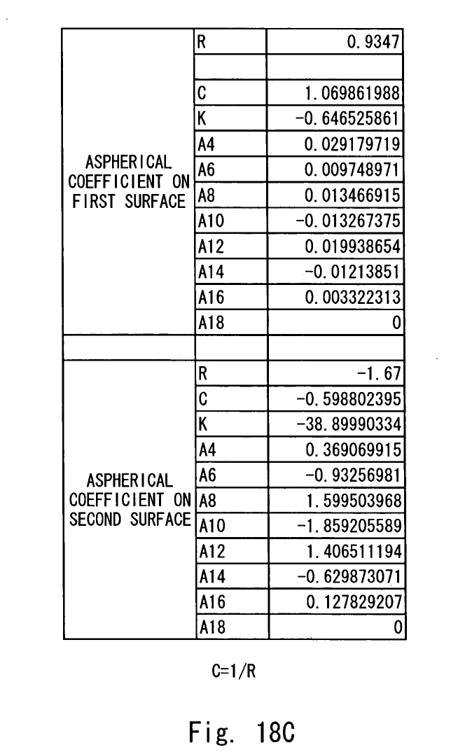

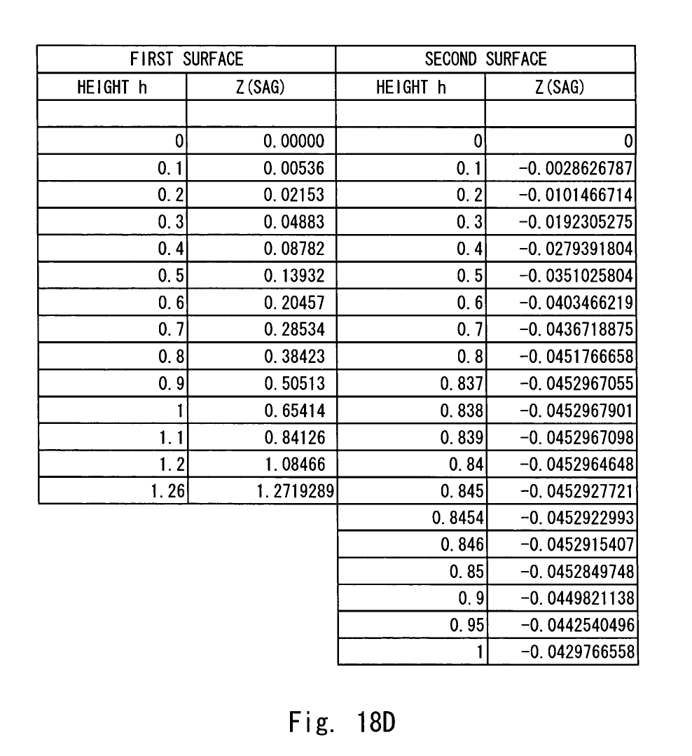

FIGS. 18A to D show specific optical data examples of the Blu-ray exclusive lens 1, and FIG. 1 shows an optical system including arrangement and an optical axis. Referring to FIG. 18D, Z (sag) is a distance in the direction parallel with an optical axis between an intersection of each surface and a straight line in parallel with the optical axis where the height along the direction perpendicular to the optical axis is h in each surface and a lens surface vertex where each surface intersects with the optical axis. The sign of Z (sag) is positive when the intersection is on the side of an optical disc with respect to the lens surface vertex (which is to the right in FIG. 1), and it is negative when the intersection is on the side of a laser (which is to the left in FIG. 1). The relationship between Z (sag) and the height h is expressed by the following expression where a curvature (1/R) on the optical axis of an aspherical surface is C, a constant of the cone is K, and an aspheric coefficient in the i-th order (even number order) is Ai. The relational expression of Z (sag) and the height h is used also in the embodiments described later.

$${Z}_{( sag )} = \frac{{Ch}^{2}}{1 + \sqrt{1 - ( K + 1 ) {C}^{2} {h}^{2}}} + {A}_{4} {h}^{4} + {A}_{6} {h}^{6} + {A}_{8} {h}^{8} + {A}_{10} {h}^{10} + {A}_{12} {h}^{12} + {A}_{14} {h}^{14} + {A}_{16} {h}^{16} + {A}_{18} {h}^{18}$$

Referring to FIGS. 18A to D and FIG. 1, light with a wavelength of 405 nm which is emitted from a blue laser (not shown) passes through a collimator lens (not shown) and becomes parallel light. It then passes through an aperture stop 3, enters the objective lens 1, and is focused thereby through a cover glass with a thickness of 0.0875 mm of a Blu-ray Disc 4. The aperture stop 3 has a circular opening with a diameter of φ2.4 mm, so that the light beam within φ2.4 can enter the objective lens 1. Because a focal length of the objective lens 1 is 1.412 mm, NA=0.85 from the following equation:
NA=(2.4/2)/1.412=0.85

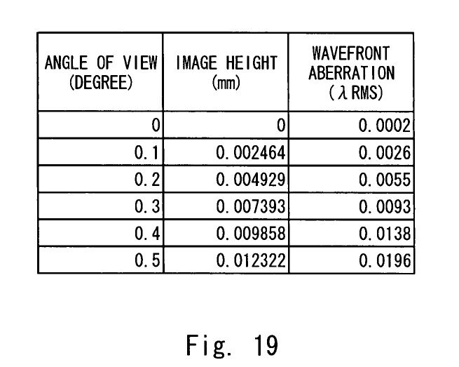

FIG. 19 shows the angle of view and the image height characteristics with respect to the wavefront aberration in the objective lens 1. The objective lens 1 has suitable wavefront aberration characteristics of less than 0.02 λrms, such as 0.0093 λrms at the angle of view of 0.3 degree, and 0.0196 λrms at the angle of view of 0.5 degree. FIG. 14A and FIG. 14B show distribution maps of the light intensity of optical spots with different vertical axis scales. The other distribution maps of the light intensity of optical spots which are used in the following description also include two light intensity distribution maps with different vertical axis scales. Referring to FIG. 14A and FIG. 14B, the light intensity of a side lobe at the position of 0.39 μm is 1.7% of the center.

As shown in FIG. 18A, the refractive index of the objective lens 1 is 1.55, and the center thickness is 1.676 mm, which is 1.18697 times the focal length. A working distance from the objective lens to the cover glass is 0.4596 mm. Because the lens of this example is a biconvex lens, a back focus is equal to the working distance, which is 0.4596 mm.

FIG. 18D is a sag table showing the lens surface shape of the objective lens 1. Referring to the second surface, a maximum value of Z (sag) is at the height of 0.838 mm. A marginal ray which is at the image height of 0 mm with NA=0.85 passes through the first surface at the height of 1.2 mm and through the second surface at the height of 0.8454 mm. Thus, the surface shape of the second surface is such that a maximum value of sag and an inflection point are within the effective optical diameter.

Referring now to the first surface, the height up to 1.2 mm is with in the effective optical diameter with NA=0.85. However, the lens surface diameter is often designed to have a margin of about several tens of μm in radius in order to allow some margin for NA, structural margin or the like. If a margin of 60 μm in radius is added, for example, the height h of a lens surface is up to 1.26 mm. The sag at the height h of 1.26 mm is 1.27193 mm, and the sag of 1.27193 mm is larger than the lens surface radius of 1.26 mm. When a lens has a large NA, such as NA=0.85, the suitable wavefront aberration characteristics as shown in FIG. 19 can be obtained if the sag of the surface on the light source side is set to be larger than the radius of the surface on the light source side or the surface on the optical disc side (opposite to the light source side) has an inflection point.

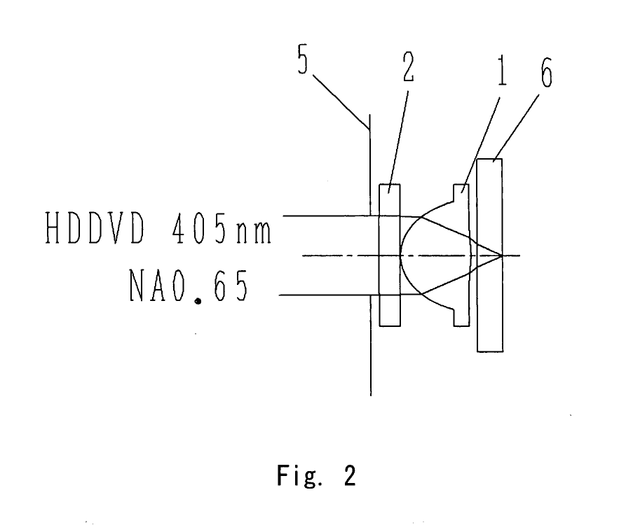

The inventor of the present invention has then discussed a way of using the above-described Blu-ray exclusive objective lens for an HDDVD. For example, by inserting an aberration correction plate 2 and an aperture stop 5 on the side of a laser with respect to the objective lens 1 as shown in FIG. 2, it is possible to form an objective lens optical system composed of the aperture stop 5, the aberration correction plate 2 and the objective lens 1, which is compatible with an HDDVD having a substrate thickness of 0.6 mm.

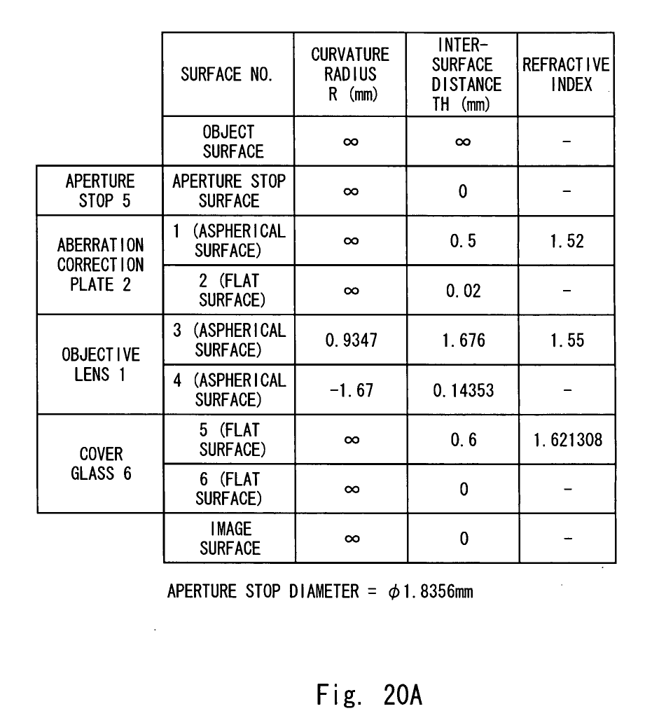

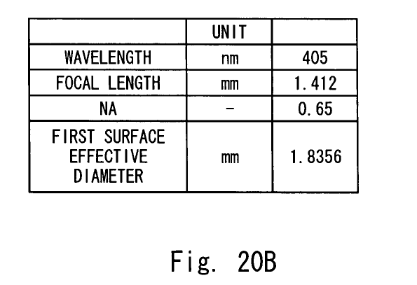

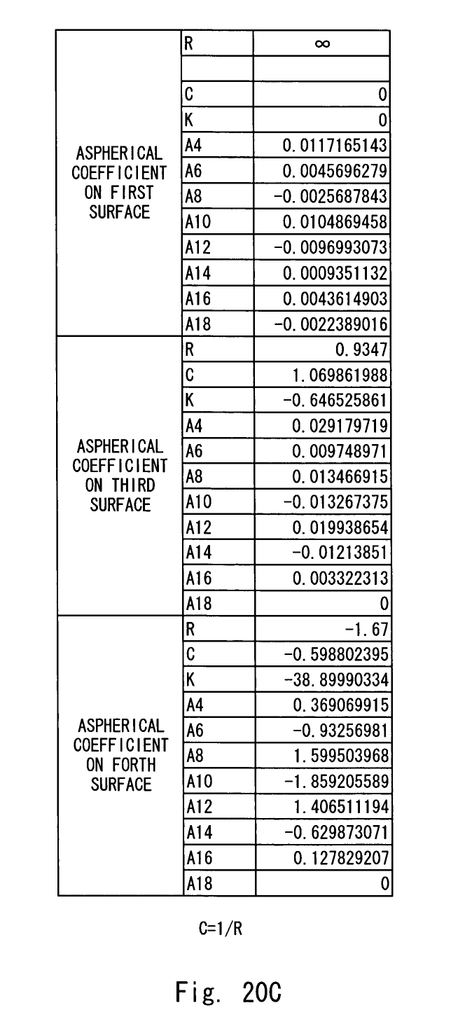

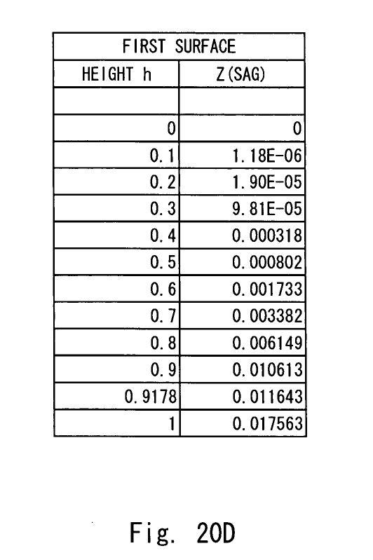

FIGS. 20A to D show specific optical data examples of the aberration correction plate 2, and FIG. 2 shows an optical system including arrangement and an optical axis. As shown in FIGS. 20A and B, a curvature radius R of the aberration correction plate 2 is ∞ in both surfaces, which means it is a no-power optical element. Thus, the entire focal length is 1.412 mm, which is the same as in a Blu-ray Disc. The objective lens 1 which has the third surface and the fourth surface shown in FIG. 20A is the same as the objective lens 1 which has the first surface and the second surface shown in FIG. 18A. As shown in FIG. 20B, NA is 0.65 and the effective diameter of the first surface is φ1.8356. As shown in FIG. 20A, the second surface of the aberration correction plate 2 is a flat surface. On the other hand, the first surface of the aberration correction plate 2 is an aspherical surface as indicated by A4 to A18 in FIG. 20C. The sag at the effective optical radius 0.9178 mm on the first surface of the aberration correction plate 2 is 0.011643 mm, thus forming an aspherical surface with the sag of about 10 μm.

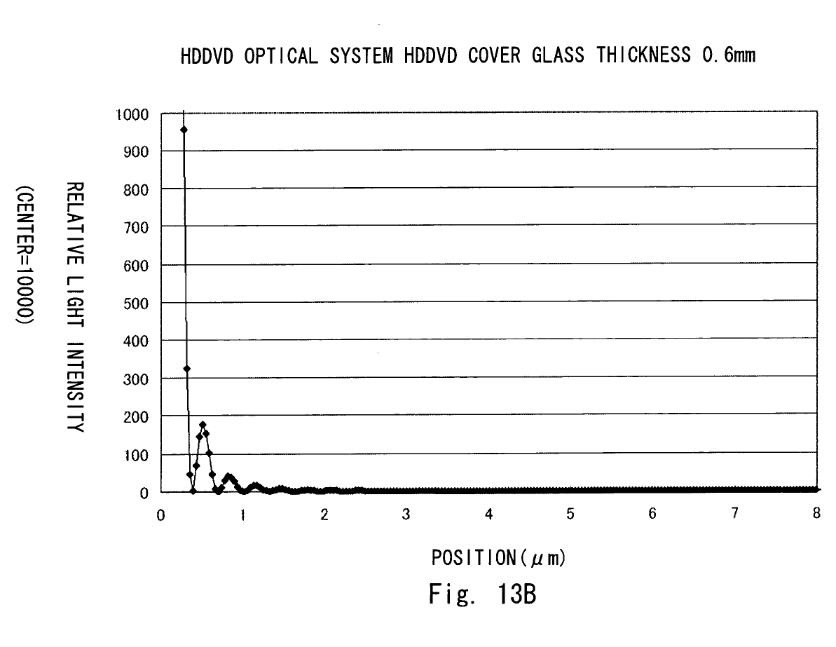

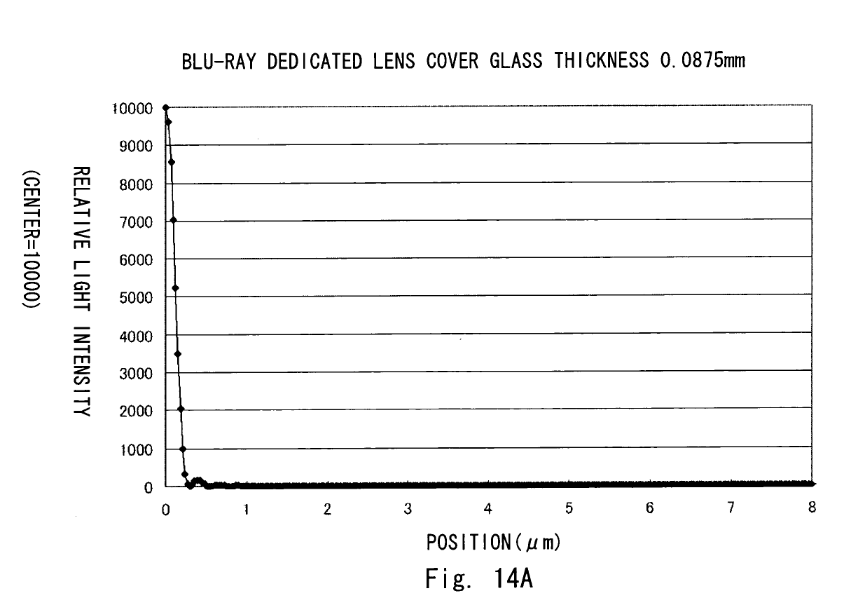

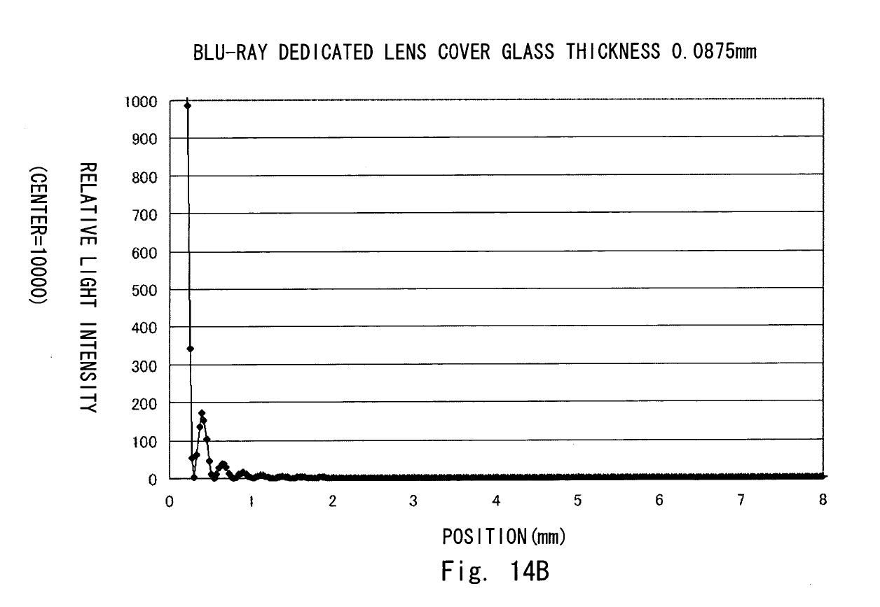

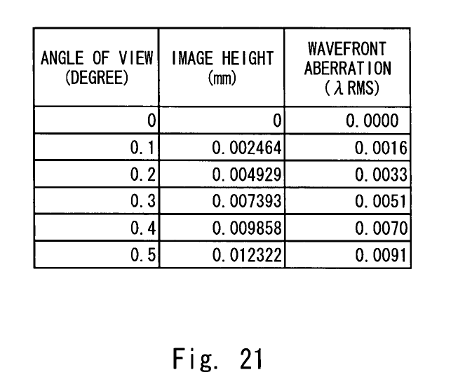

FIG. 21 shows the angle of view and the image height characteristics with respect to the wavefront aberration in the optical system shown in FIGS. 20A to D. FIGS. 13A and 13B are distribution maps of the light intensity of optical spots in the optical system shown in FIGS. 20A to D. In FIGS. 13A and 13B, a side lobe at the position of 0.51 μm is 1.8%.

As described in the foregoing, by inserting the aperture stop 5 and the aberration correction plate 2 into the optical system, suitable wavefront aberration of 0.01 λrms or smaller can be obtained as shown in FIG. 21 for an HDDVD with a cover glass thickness of 0.6 mm using the Blu-ray exclusive optical lens while the optical system remains infinite. If it is difficult to insert the aberration correction plate 2, it is feasible to insert the aperture stop 5 only and change the optical system into a finite system.

Further, in the system shown in FIGS. 18A to D, if a distance from the object surface to the objective lens 1 is set to 14.95 mm, wavefront aberration of 0.0524 λrms with NA=0.65 can be obtained, which is within the Marechal criterion of 0.07 λrms. In order to implement compatibility between a Blu-ray Disc and an HDDVD in this system, the optical disc apparatus needs to include a mechanism for inserting and removing the aberration correction plate 2 and the aperture stop 5.

Another system for implementing compatibility between a Blu-ray Disc and an HDDVD is described hereinafter. As described earlier, the aberration correction plate 2 which is specified by FIGS. 20A to D implements the function of aberration correction on the aspherical surface of the first surface so as to allow a Blu-ray optical system to be used as an HDDVD optical system. If the first surface of the aberration correction plate 2 which is specified by FIGS. 20A to D is changed from an aspherical surface to a flat surface, the aberration correction plate 2 does not have the function of aberration correction, so that it is a Blu-ray optical system rather than an HDDVD optical system.

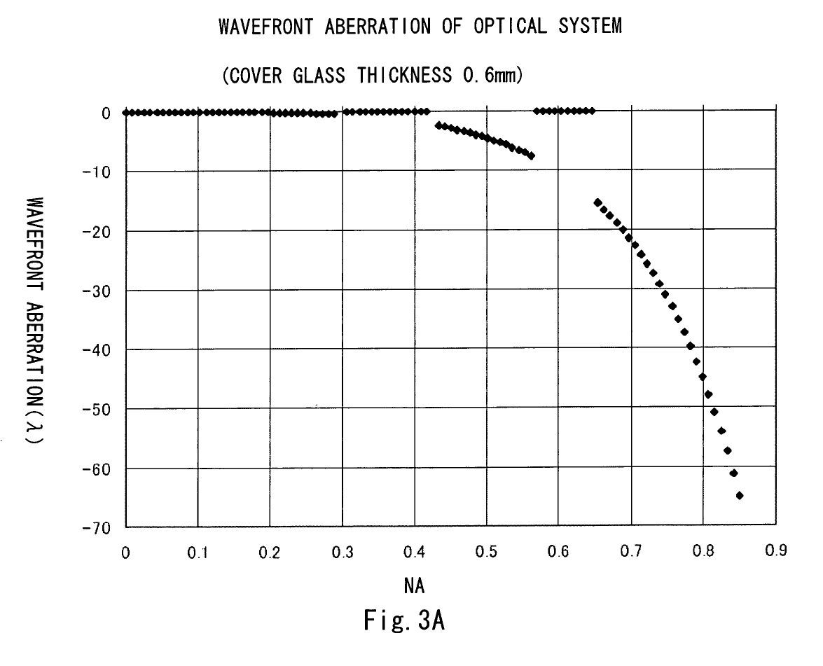

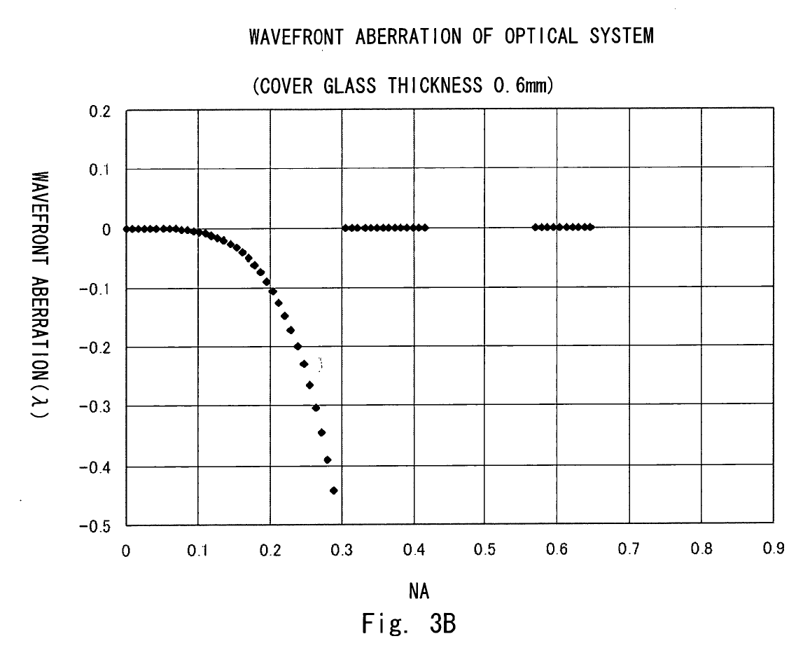

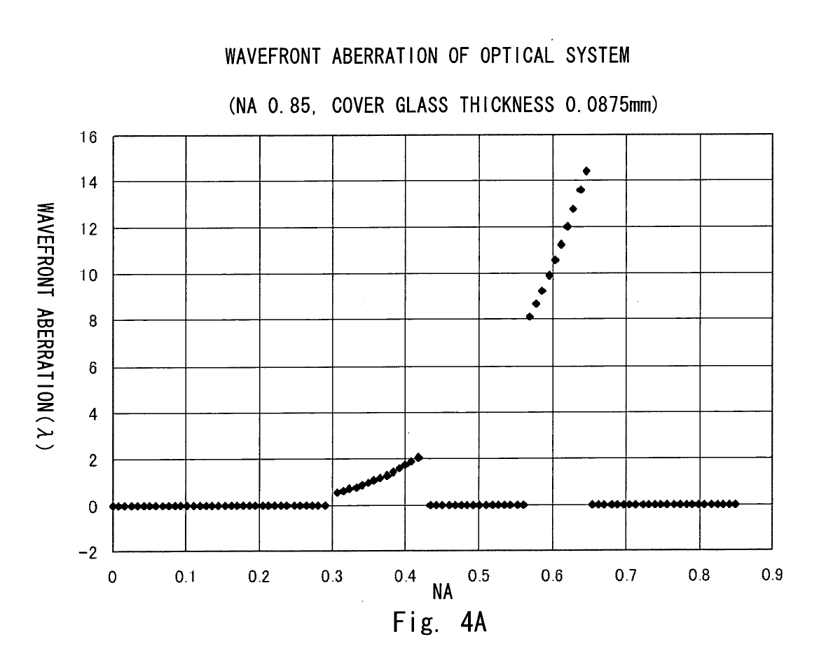

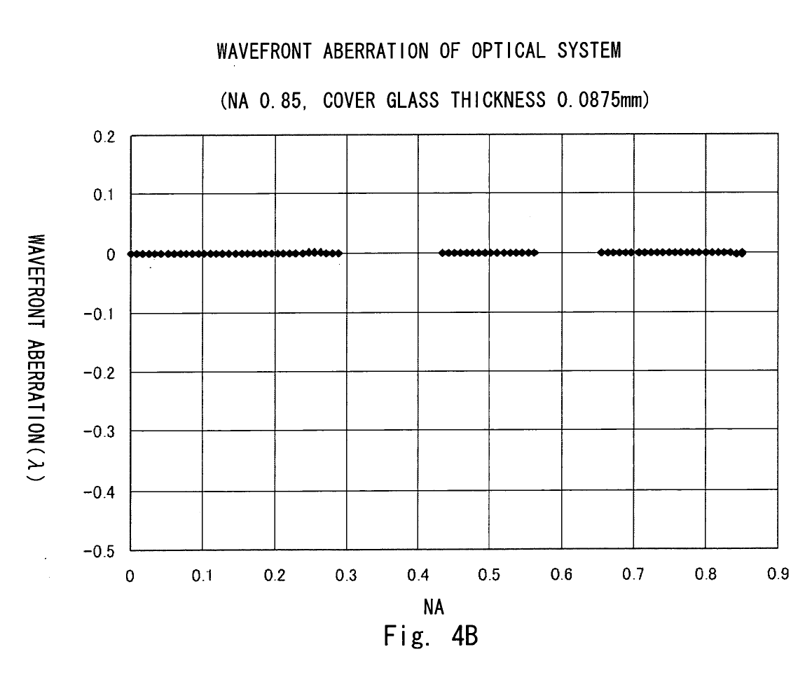

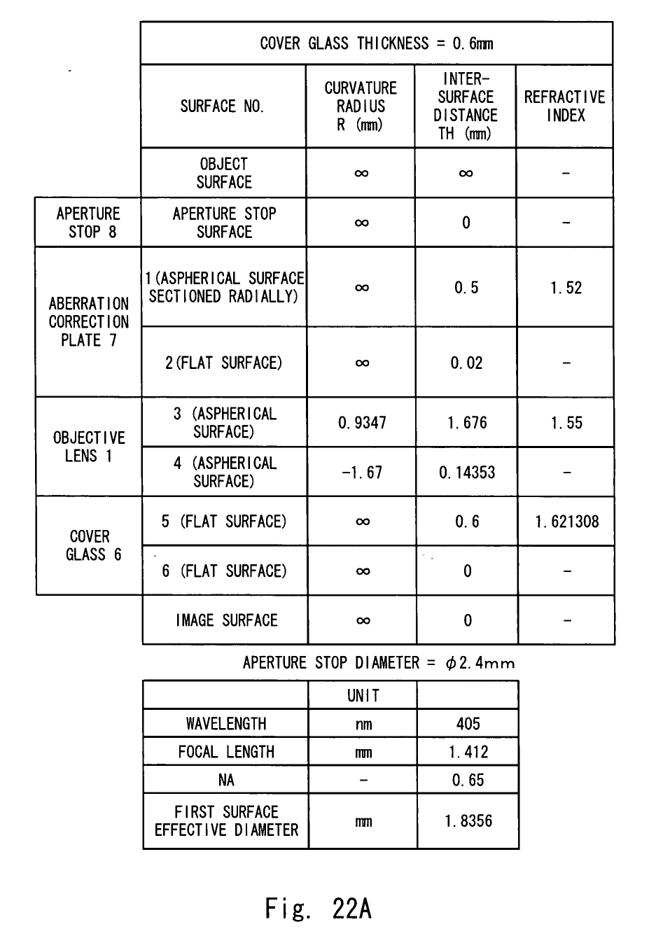

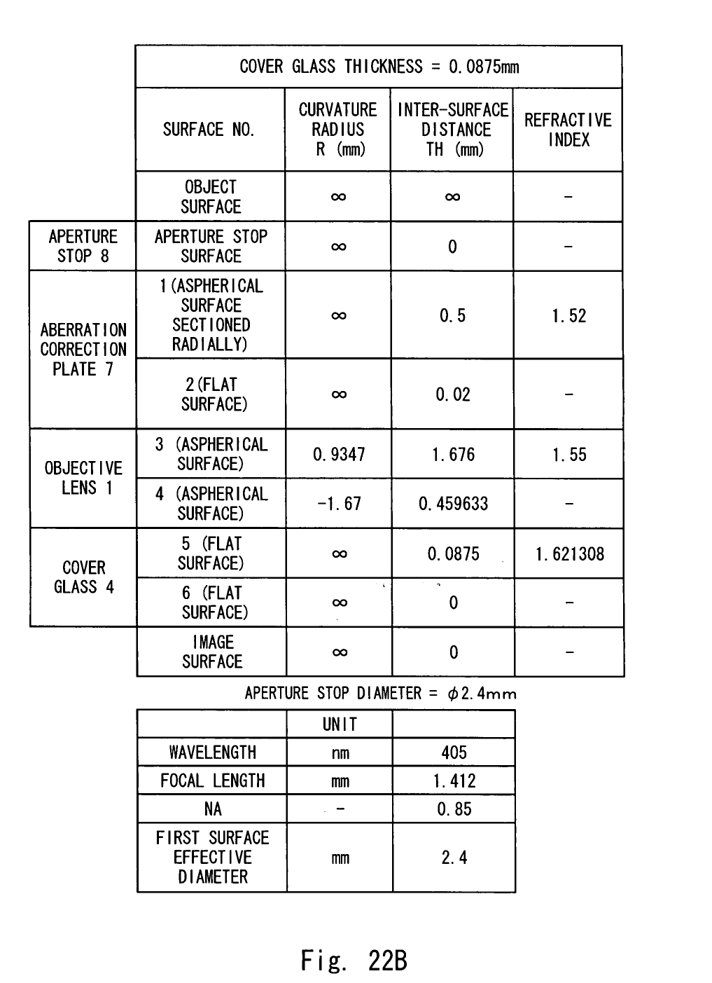

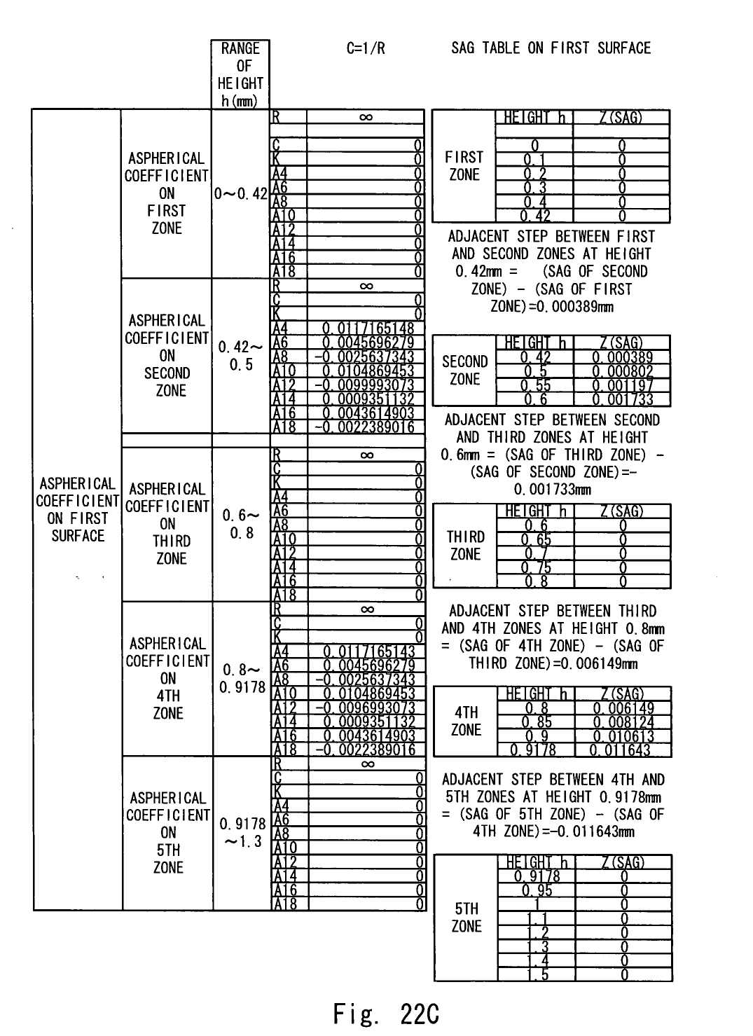

Therefore, in the present embodiment, the first surface of the aberration correction plate 2 is sectioned into a flat surface and an aspherical surface for each zone along the radial direction. FIGS. 22A to C show the optical data examples of the aberration correction plate in this case. FIG. 22 shows an aberration correction plate 7 which is sectioned into five ring zones along an optical axis. FIGS. 3A and 3B show wavefront aberration charts of the optical system in which a cover glass thickness is 0.6 mm as shown in FIG. 22A. FIGS. 4A and 4B show wavefront aberration charts of the optical system in which a cover glass thickness is 0.0875 mm as shown in FIG. 22B. FIGS. 3A and 3B and FIGS. 4A and 4B are respectively the same wavefront aberration charts with different vertical axis scales.

In FIG. 3A, FIG. 3B, FIG. 4A and FIG. 4B, NA0 to NA0.297 correspond to the height 0 to 0.42 mm in the first zone. As shown in FIG. 3A and FIG. 3B, if a cover glass has a thickness of 0.6 mm, the wavefront aberration in the first zone is 0 to −0.45λ. As shown in FIG. 4A and FIG. 4B, if a cover glass has a thickness of 0.0875 mm, the wavefront aberration in the first zone is 0λ, thus exhibiting suitable wavefront aberration.

In the second and fourth zones, the wavefront aberration is 0λ, which is suitable, when a cover glass has a thickness of 0.6 mm as shown in FIG. 3A and FIG. 3B. In the third and fifth zones, the wavefront aberration is 0λ, which is suitable, when a cover glass has a thickness of 0.875 mm as shown in FIG. 4A and FIG. 4B.

The number of zones may be as large as several tens, for example, in design. However, because an adjacent step of about several to ten micrometers occurs at a boundary between zones, too many zones causes a complicated shape, which is difficult to manufacture, and it is thus preferred to design the surface to have a relatively small number of zones.

From this point of view, it may be designed to have three zones, in which the second zone has a surface shape for an HDDVD with NA=0.65 or less, and the third zone has a surface shape for a Blu-ray with NA=0.65 to 0.85. However, because both an HDDVD and a Blu-ray Disc have large NA of 0.65 and 0.85, respectively, it is difficult to form a suitable optical spot shape. Accordingly, this embodiment forms five zones by adding one HDDVD zone and one Blu-ray zone to the three zones. The outermost zone is a Blu-ray zone with a large NA.

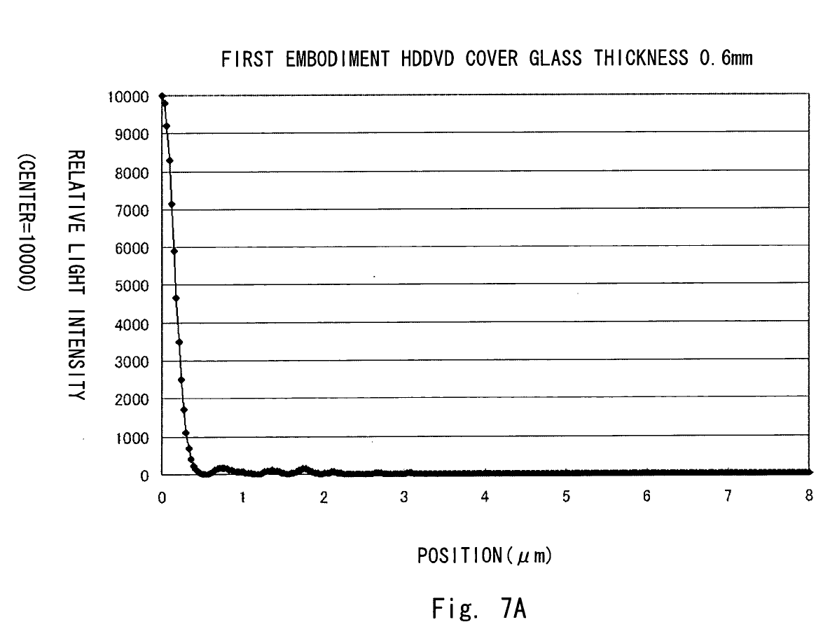

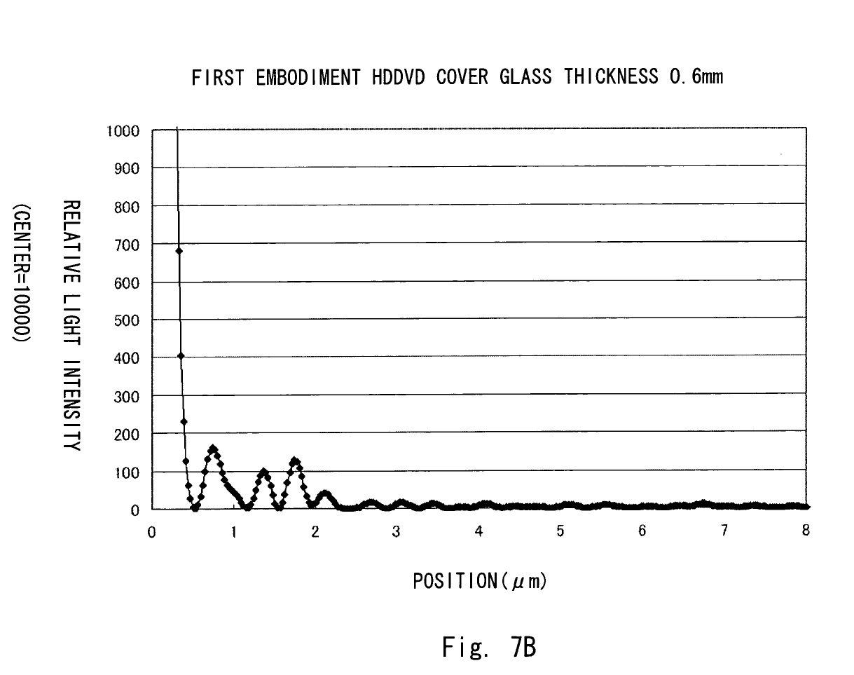

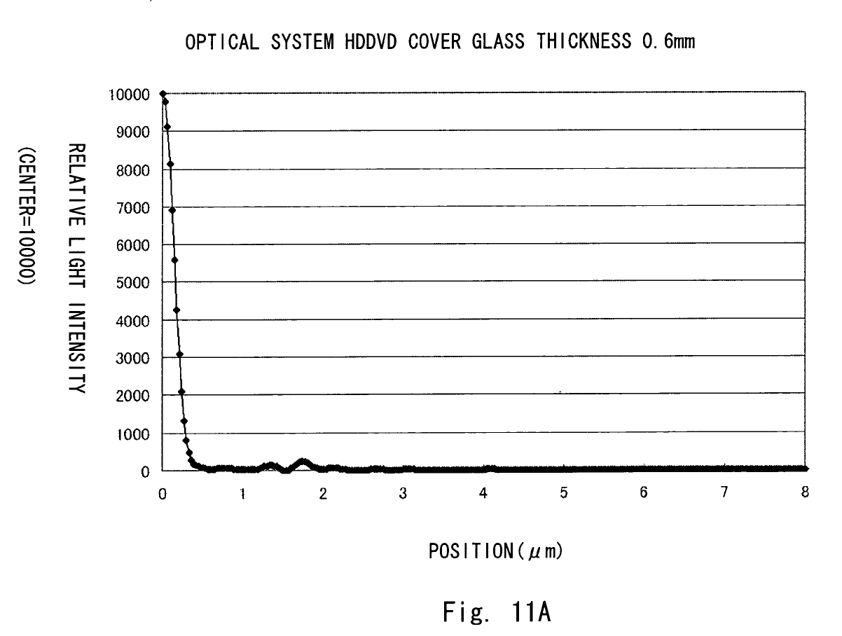

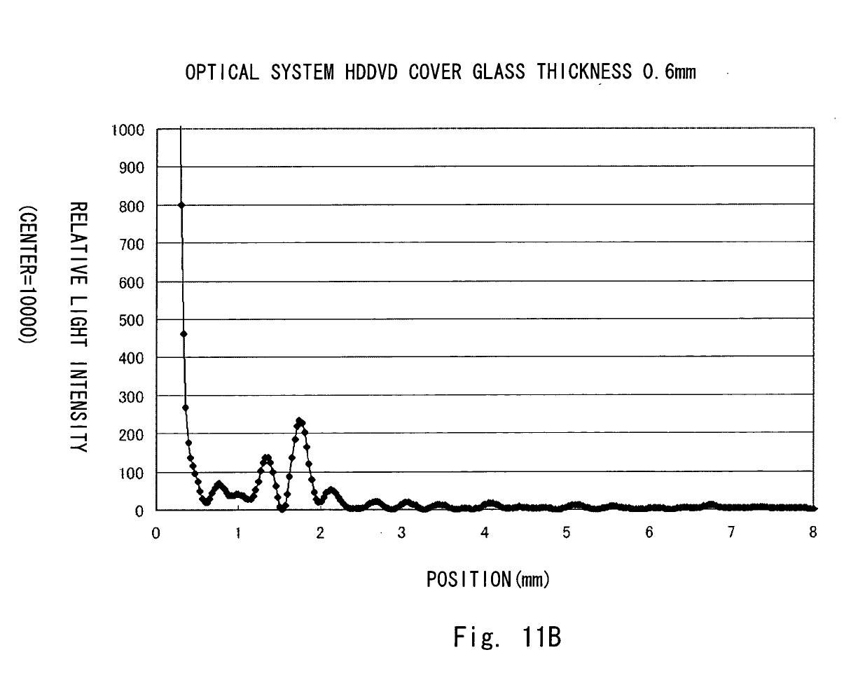

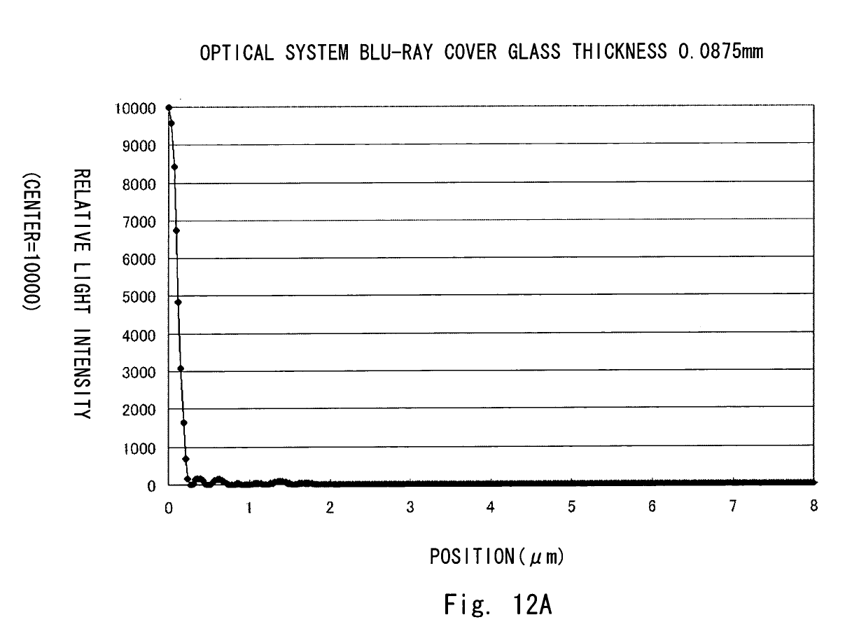

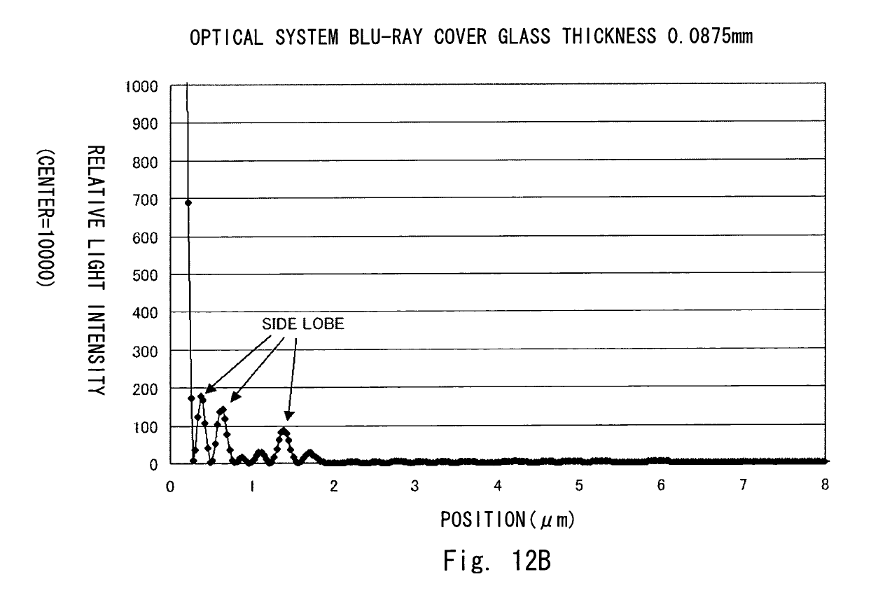

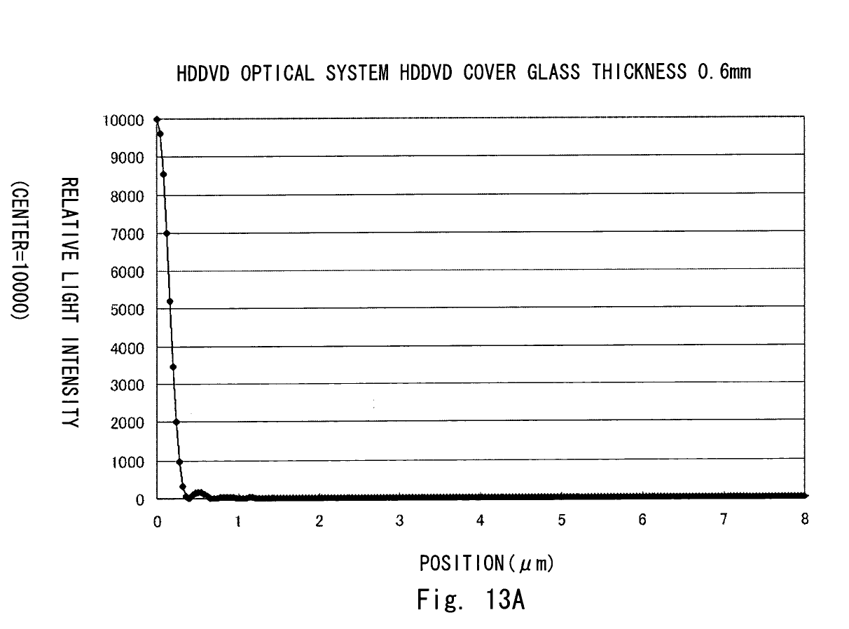

FIG. 11A, FIG. 11B, FIG. 12A and FIG. 12B show wave-optic optical spot charts of this reference example. The optical spot charts in FIG. 12A and FIG. 12B show distribution maps of the light intensity of optical spots of Blu-ray. In FIG. 12A and FIG. 12B, the horizontal axis indicates the position on an image surface, which indicates a distance from the lens optical axis, and the vertical axis indicates the relative light intensity. The vertical axis of FIG. 12B is 1/10 scale of the vertical axis of FIG. 12A so as to clearly show the relatively low light intensity of about 200 or lower. The format of the optical spot charts in FIG. 12 is the same in FIGS. 7 to 11, 13 and 14.

Referring to the optical spot charts of FIGS. 12A and 12B, a maximum side lobe is at the position of 0.39 μm where the light intensity is 1.8% relative to the center, which is substantially the same as 1.7%, the value in the Blu-ray exclusive lens shown in FIG. 14A and FIG. 14B. However, referring to the optical spot of an HDDVD optical system shown in FIG. 11A and FIG. 11B, the relative light intensity is 2.3% at the position of 1.8 μm, which is relatively large. The light intensity of a side lobe is 1.8% at the optical spot of an HDDVD exclusive optical system shown in FIG. 13A and FIG. 13B.

The inventor of the present invention has further discussed a way of reducing a side lobe for an HDDVD. As obvious from FIG. 4A and FIG. 4B, the first, third and fifth zones have no aberration for a cover glass with a thickness of 0.0875 mm, which corresponds to an average thickness of a Blu-ray Disc, so that they are lens surface use regions for a Blu-ray Disc. On the other hand, referring to FIG. 3B, despite the fact that the first zone has no aberration for a Blu-ray Disc, it also has the wavefront aberration of 0 to −0.1λ, which is suitable, for an HDDVD in the region with NA=0 to 0.2 and further has the wavefront aberration of −0.1 to −0.45λ in the region with NA=0.2 to 0.297, which is still better than −2 to −8λ in the third zone. Thus, for an HDDVD, the second and fourth zones are definitely lens surface use regions for an HDDVD because there is no aberration, and the first zone can be also a region that is used to some extent. Accordingly, the first, second and fourth regions serve as the lens surface use regions for an HDDVD, and therefore it is preferred to design a lens surface shape in such a way that it does not achieve no aberration only with the second and fourth zones, but it produces the best performance including the first zone also.

Given the above facts, the wavefront aberration for an HDDVD in the second zone should be set not to zero as in FIG. 3 but to a negative value for obtaining better average wavefront aberration in an HDDVD because the wavefront aberration in the first zone is also a negative value. Although the wavefront aberration in the first zone is 0 to −0.45λ for an HDDVD in FIG. 3, it is preferred to make the value of −0.45λ closer to positive in order to improve the average wavefront aberration. Preferably, the value exceeds −0.40λ.

### FIRST EMBODIMENT

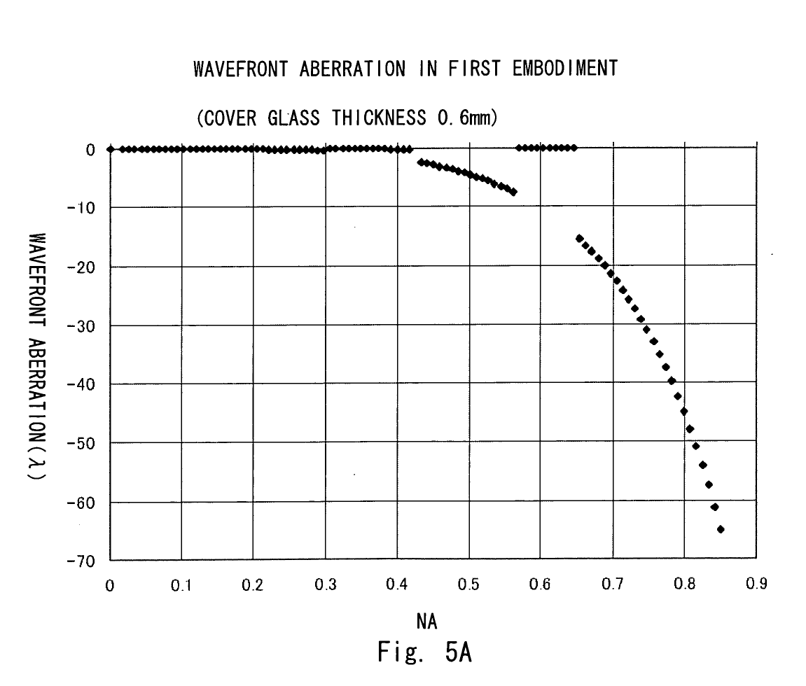

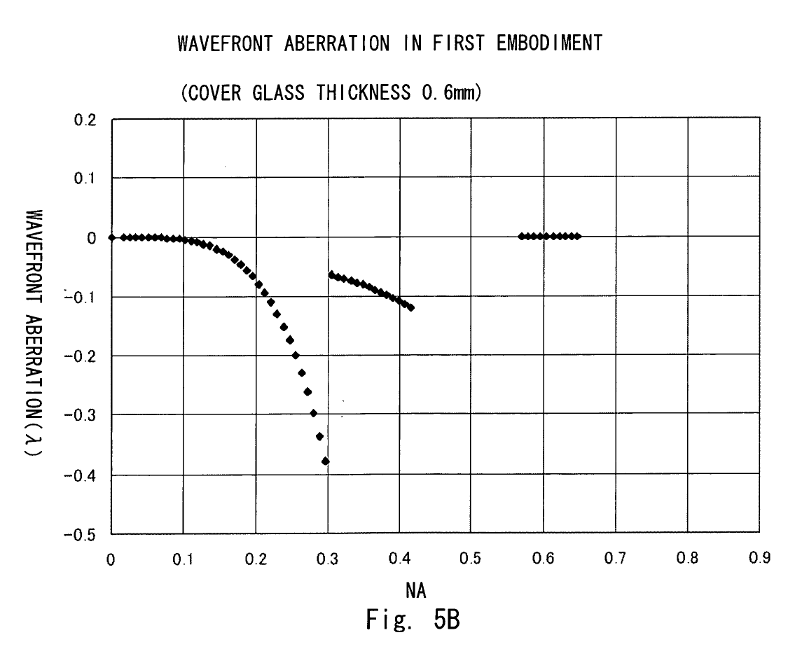

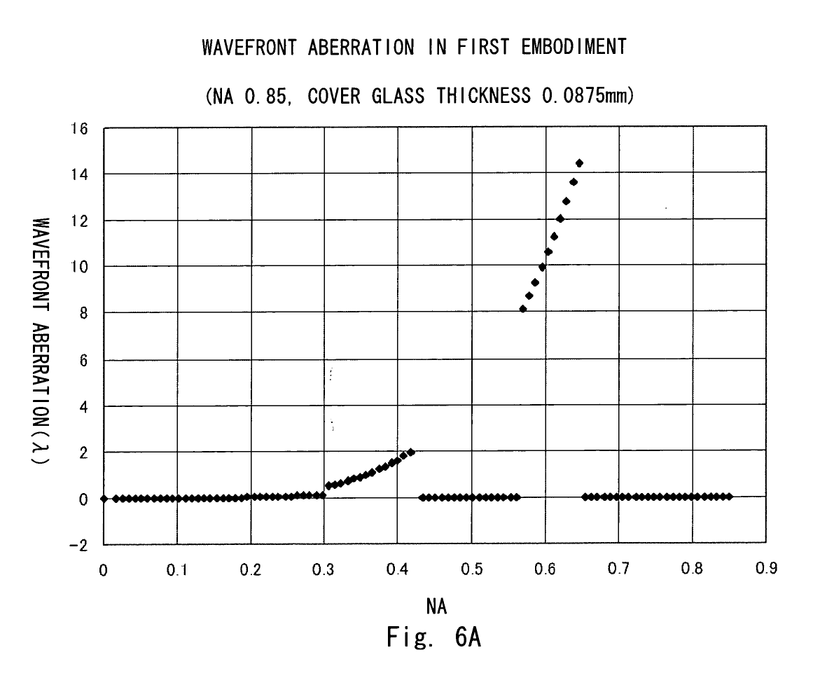

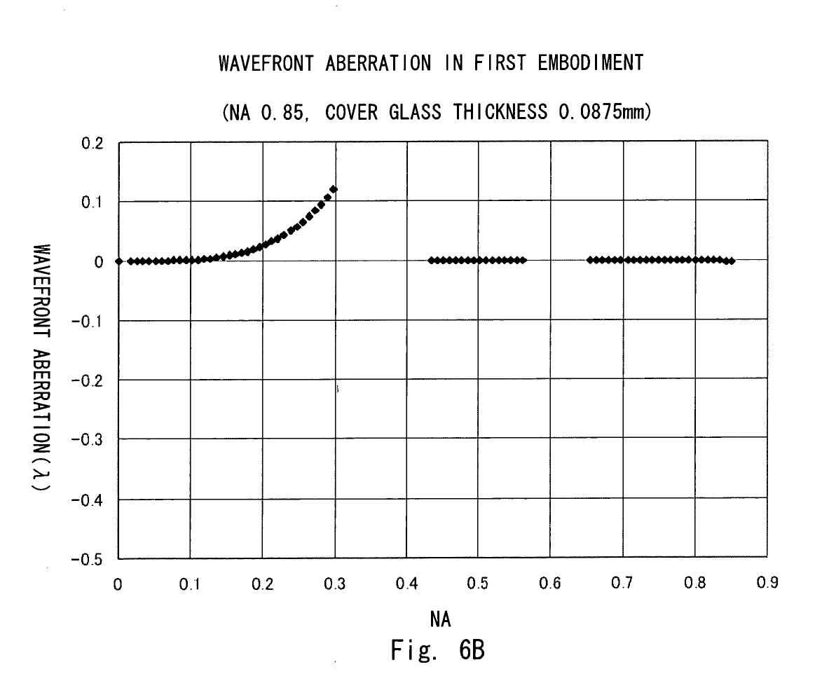

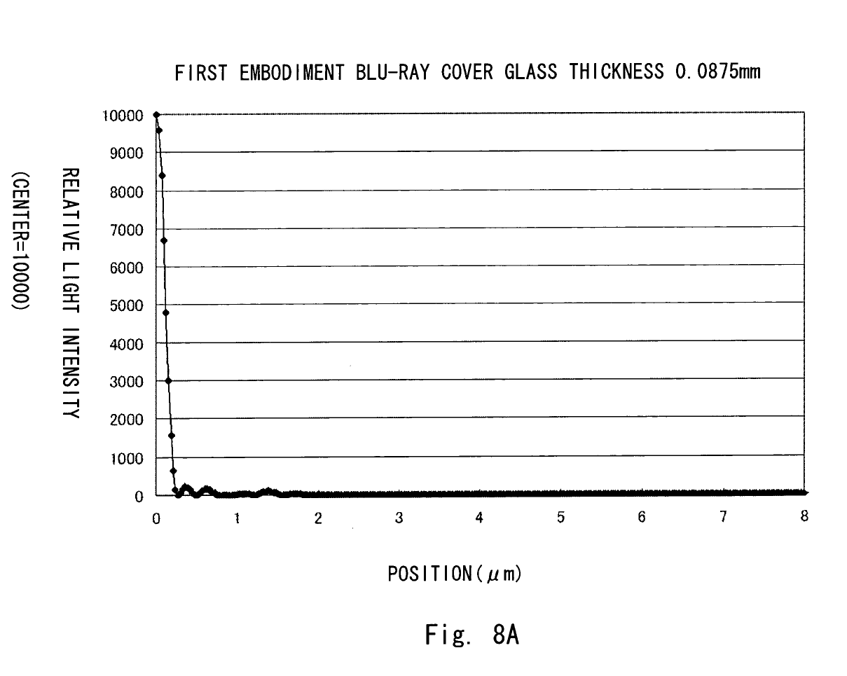

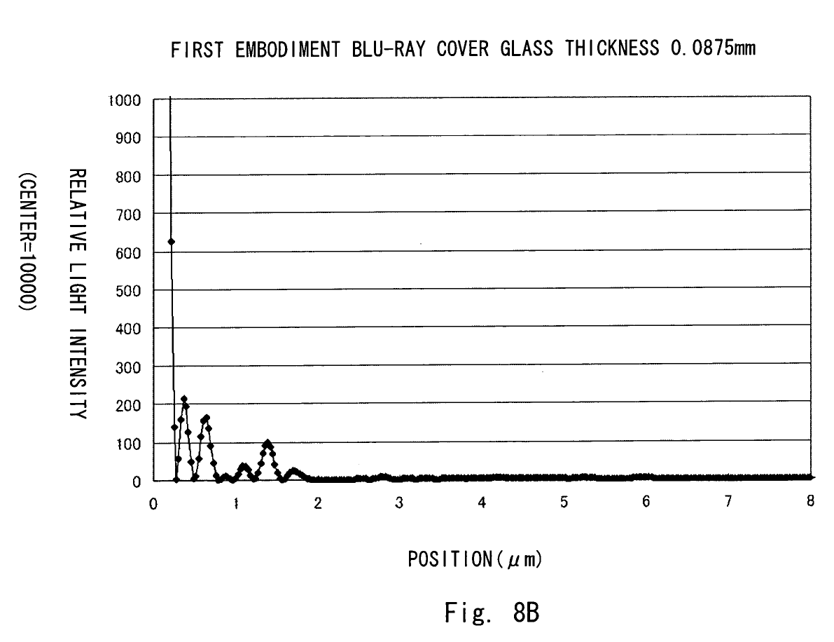

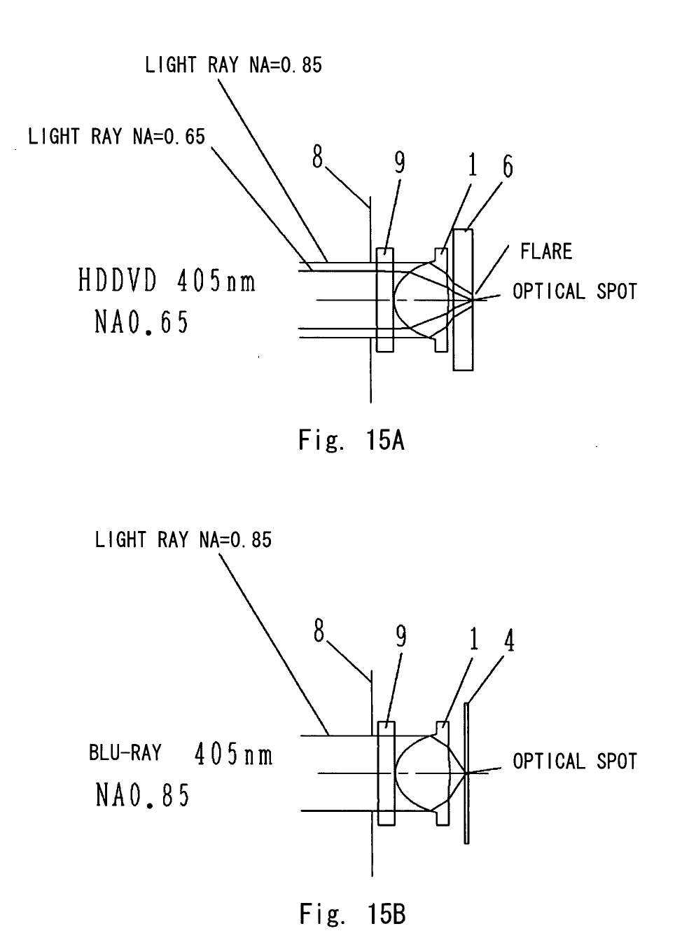

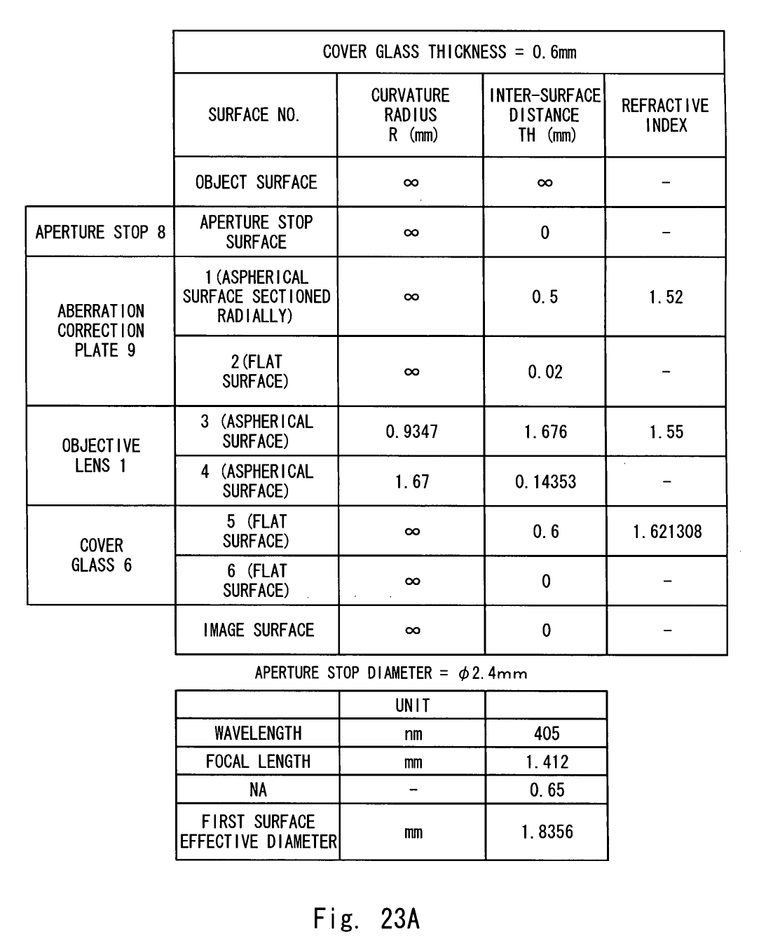

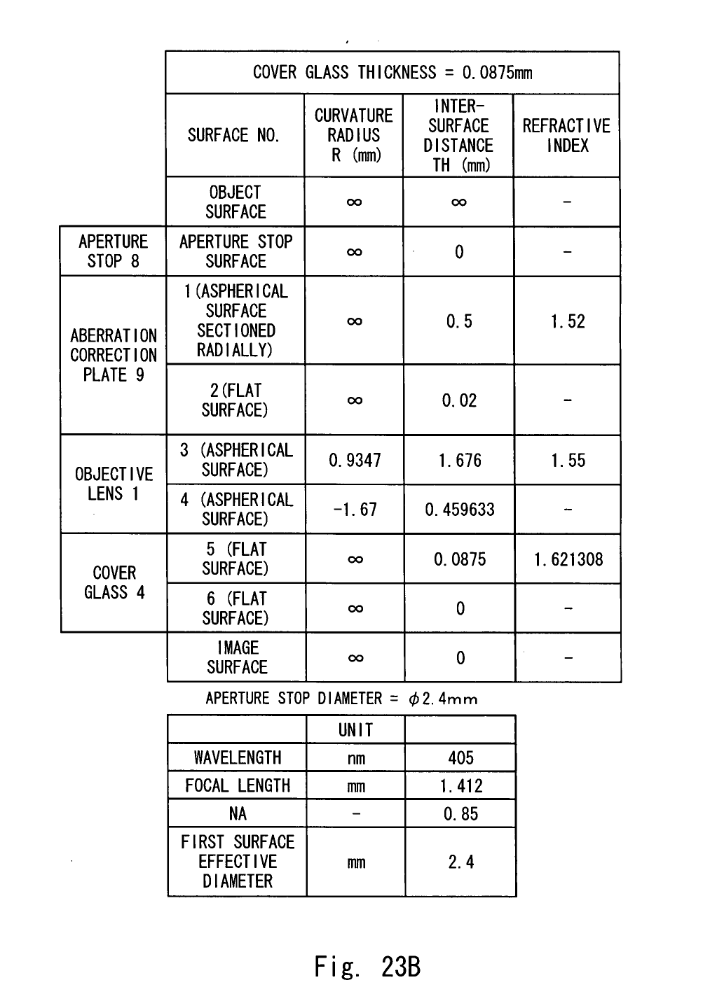

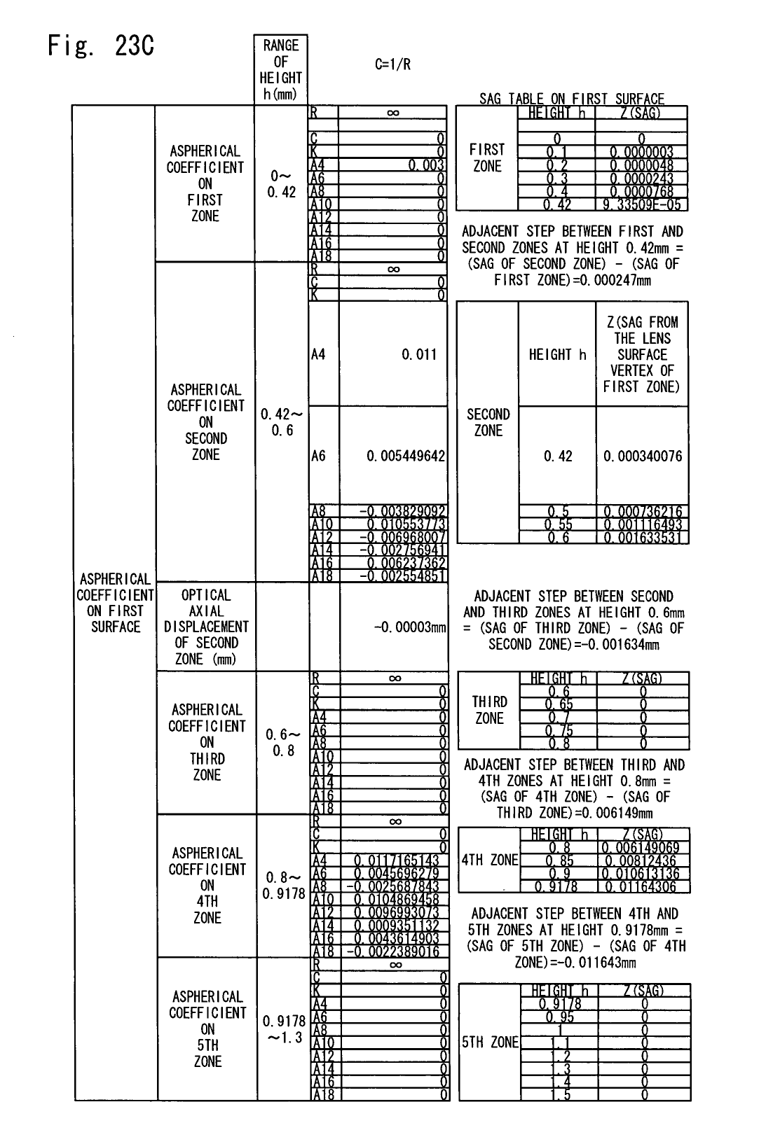

FIG. 23A, FIG. 23B and FIG. 23C show the configuration of the optical system and the lens data of the first embodiment of the present invention which includes an aberration correction plate 9 where the first zone and the second zone are modified. FIG. 5A, FIG. 5B, FIG. 6A and FIG. 6B show the wavefront aberration charts of the same. FIG. 7A, FIG. 7B, FIG. 8A and FIG. 8B show the optical spot charts of the same. FIG. 15A and FIG. 15B show the arrangement of the optical system. As shown in FIG. 15B, an optical spot of NA=0.85 is formed when using a Blu-ray Disc. The diameter of an aperture stop is φ2.4 mm as shown in FIG. 23B.

In the first embodiment, the first zone is a common region which suitably focuses light on optical discs of both a Blu-ray Disc and an HDDVD, the second and fourth zones are HDDVD exclusive regions which suitably focus light on an HDDVD, and the third and fifth zones are Blu-ray exclusive regions which suitably focus light on a Blu-ray Disc.

FIG. 15A shows light rays when using an HDDVD, which form an optical spot of NA=0.65. The objective lens 1 has a shape such that the light ray of NA0.65 to NA0.85 becomes flare and does not contribute to an optical spot.

Referring to the wavefront aberration charts in FIG. 5A, FIG. 5B, FIG. 6A and FIG. 6B, the aberration in the first zone is 0.11λ at NA=0.3 for a Blu-ray disc as shown in FIG. 6A and FIG. 6B, which is not so degraded on average. This is also explained from the optical spot charts of FIG. 8A and FIG. 8B.

As shown in FIG. 5A and FIG. 5B, the wavefront aberration in the first zone for an HDDVD is improved to −0.38λ, which exceeds −0.40λ. The wavefront aberration in the second zone is −0.07 to −0.12λ, which is closer to that of the first zone. In the second and fourth zones, the wavefront aberration differs by 0.09λ on average. In the optical spot on a Blu-ray Disc shown in FIG. 8A and FIG. 8B, a side lobe is 2.1% at the position of 0.36 μm. In the optical spot on an HDDVD shown in FIG. 7A and FIG. 7B, a side lobe is 1.6% at the position of 0.74 μm.

In the reference example which is described earlier with reference to FIG. 22, a side lobe of a Blu-ray spot is 1.8%, and a side lobe of an HDDVD is 2.3%. In the first embodiment, on the other hand, they are 2.1% and 1.6%, respectively, indicating that it deteriorates by 0.3% for a Blu-ray Disc and improves by 0.7% for an HDDVD, so that a less suitable value improves from 2.3% to 2.1%. This is the effect of changing the surface shape of the first surface of the aberration correction plate so as to improve the wavefront aberration as shown in FIG. 5A, FIG. 5B, FIG. 6A and FIG. 6B.

### SECOND EMBODIMENT

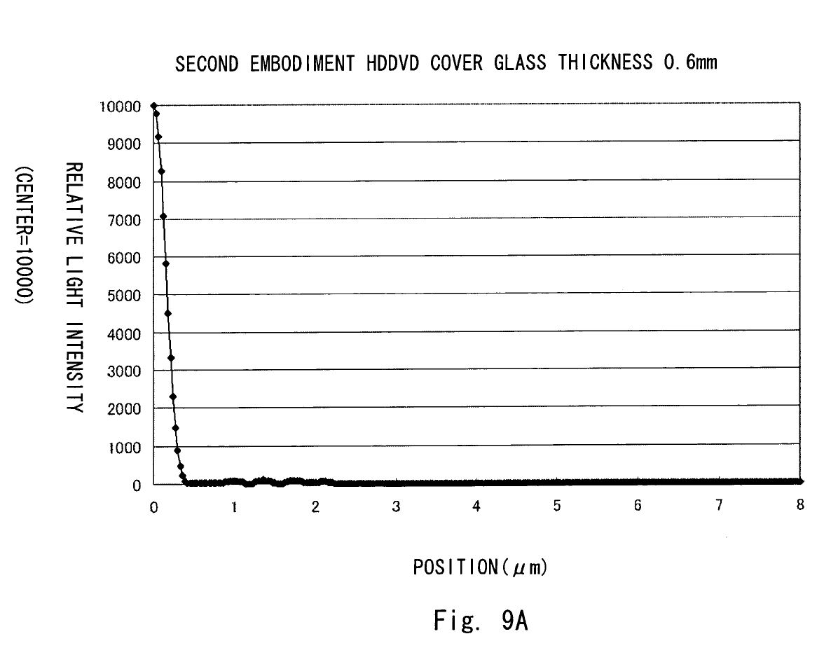

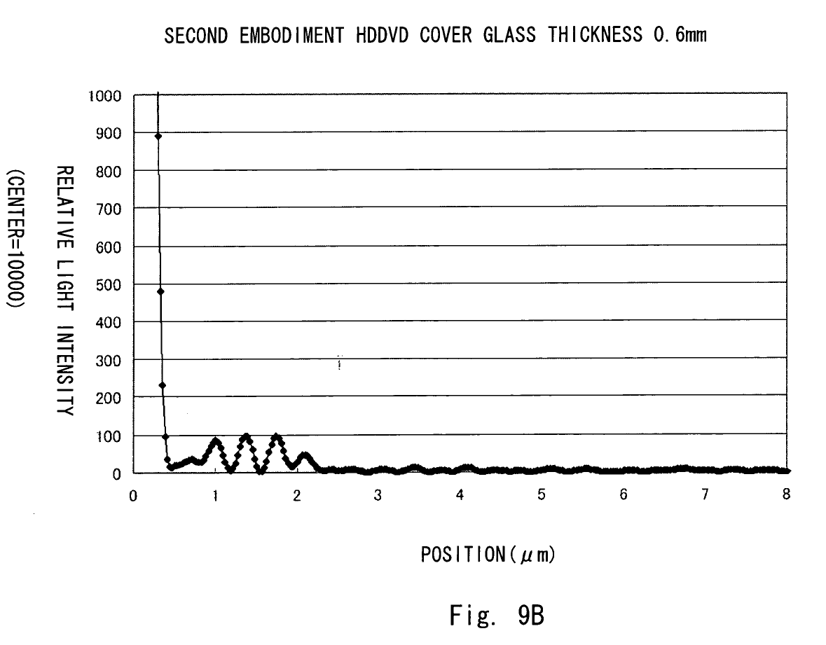

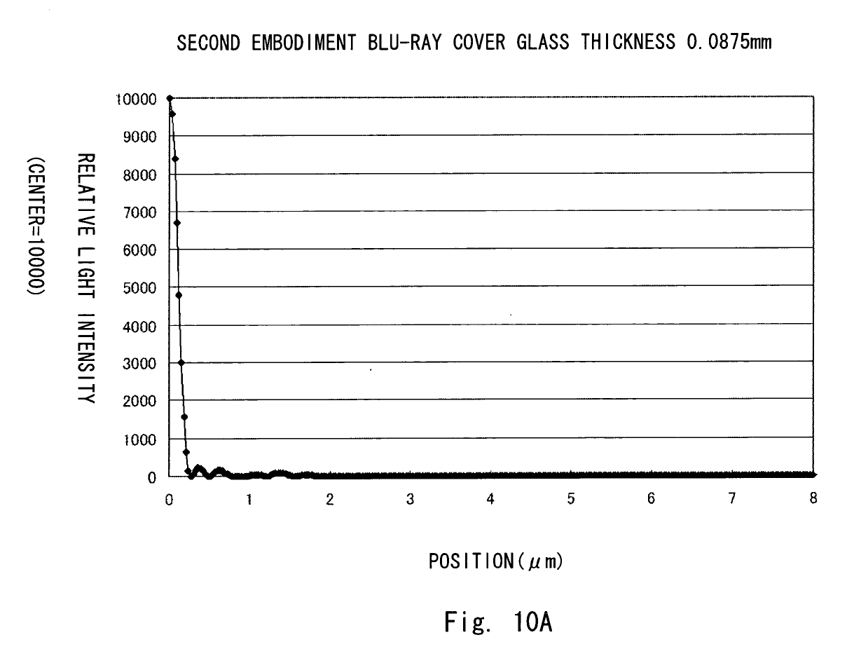

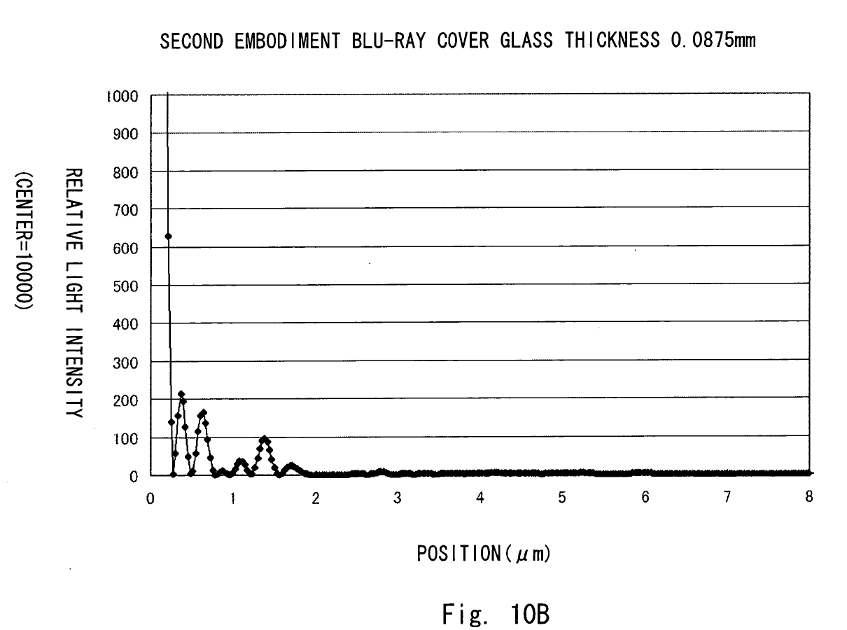

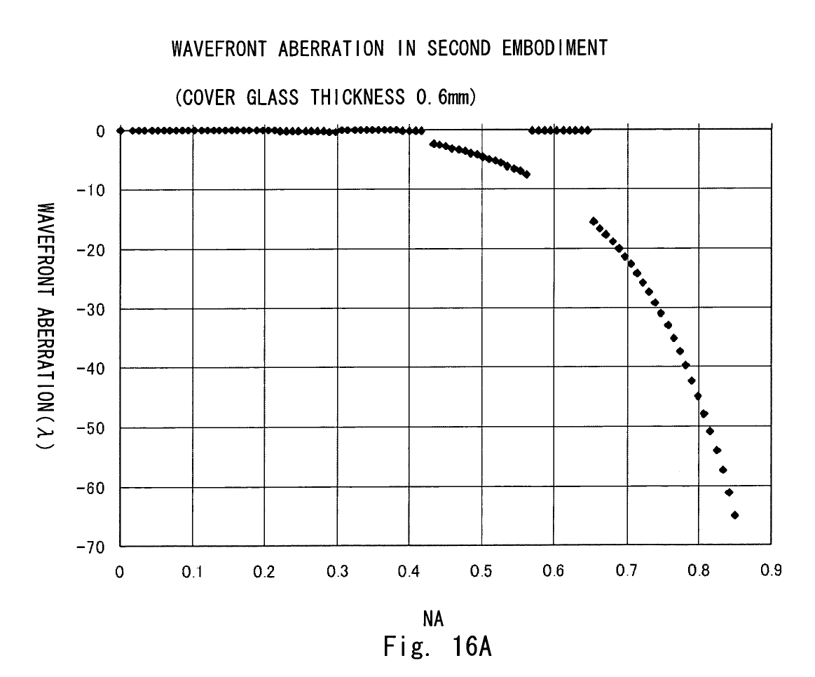

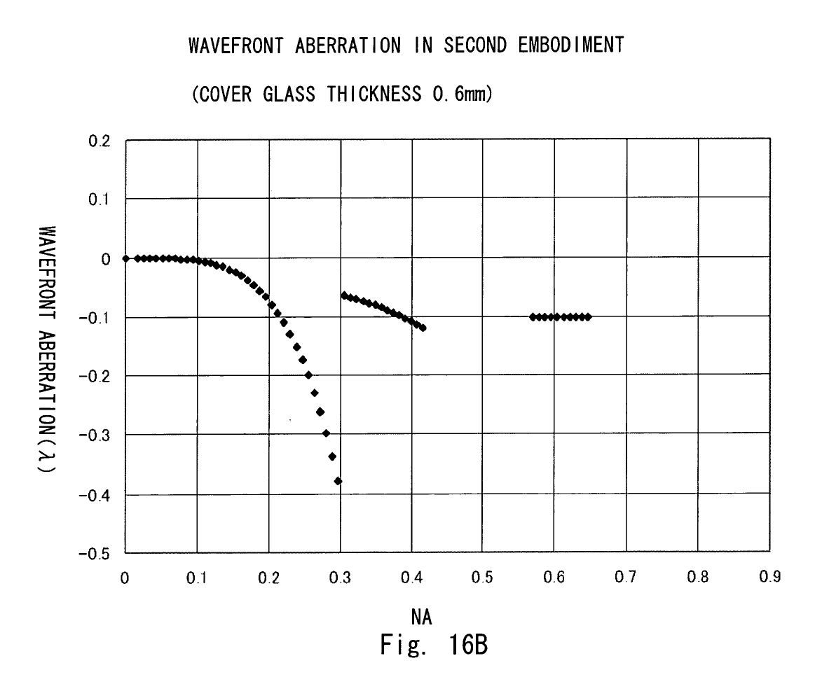

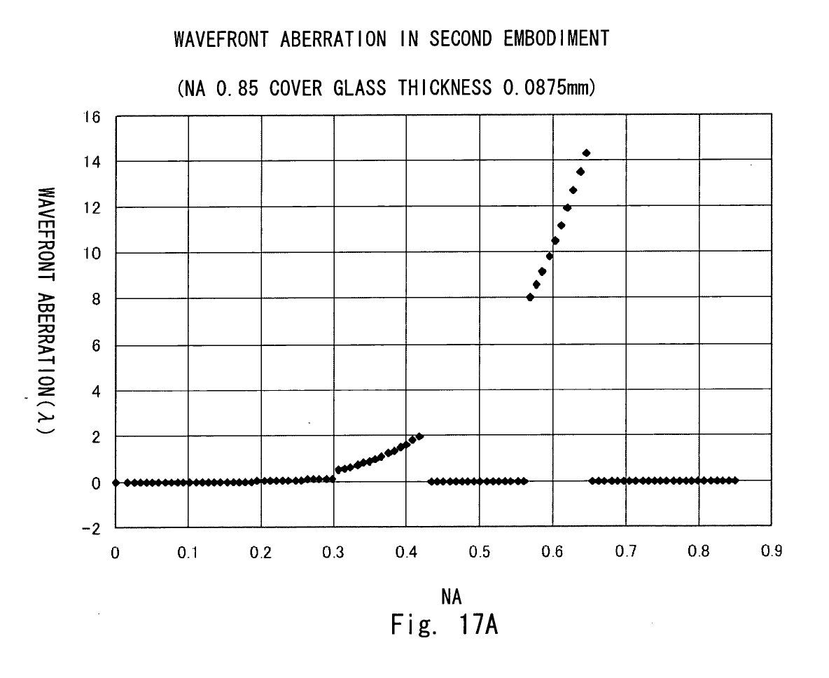

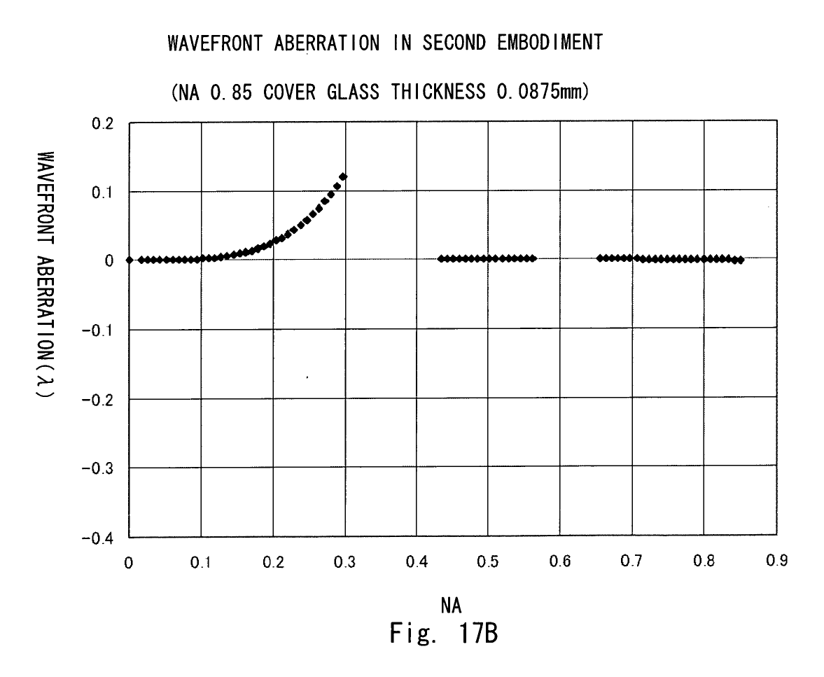

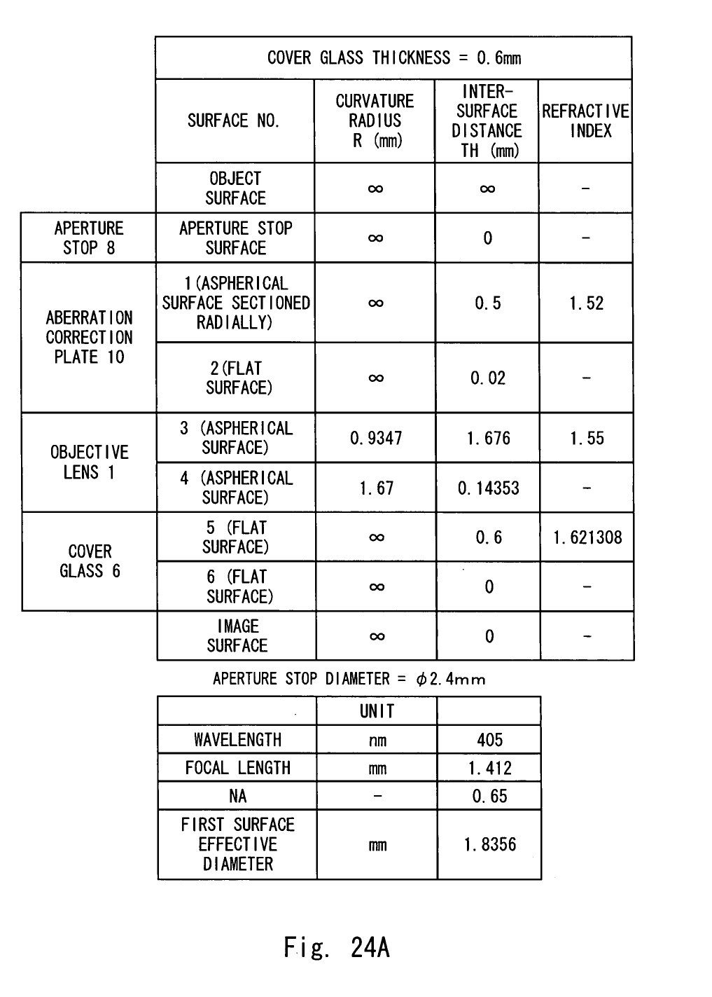

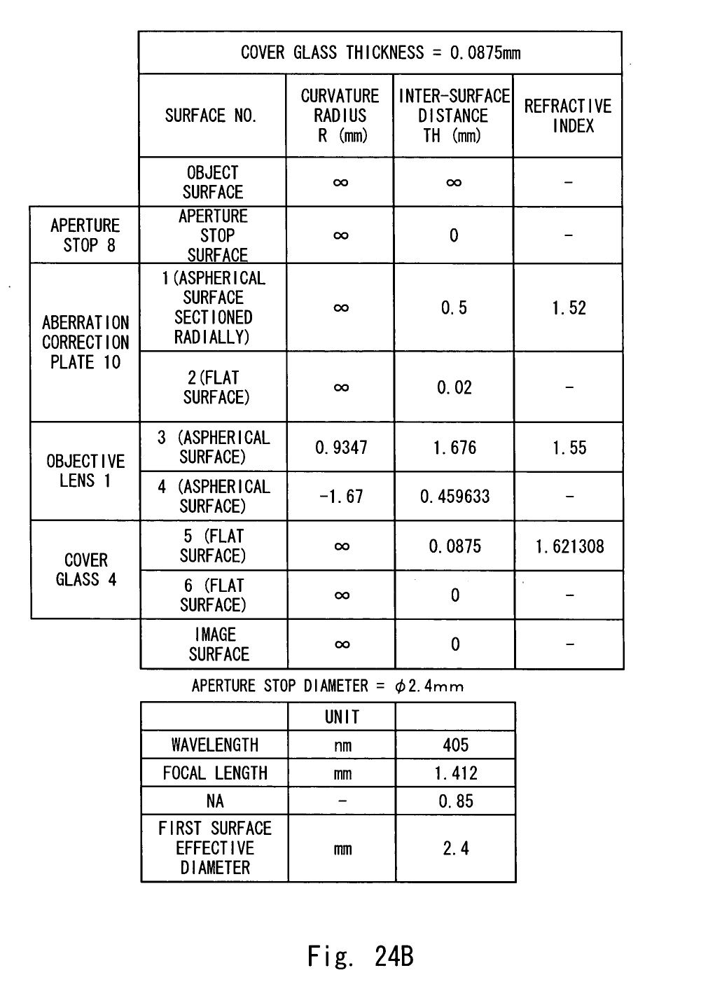

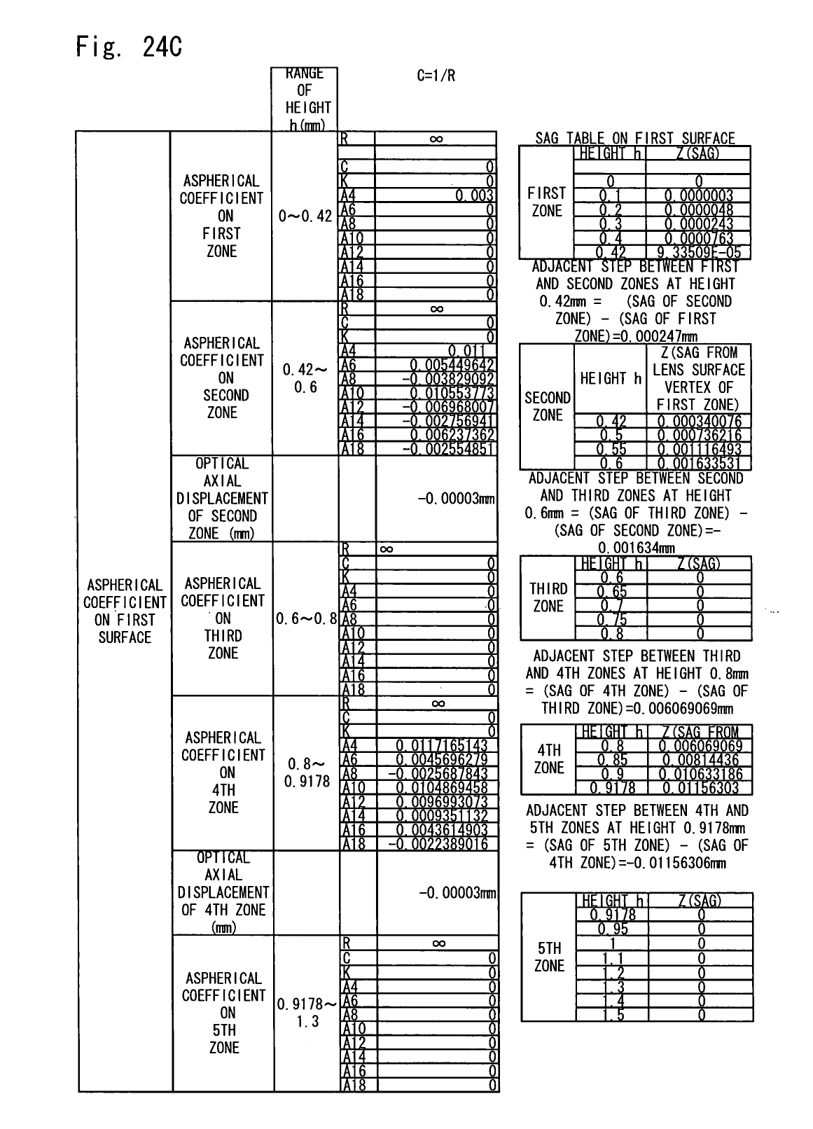

Although the wavefront aberration for an HDDVD is zero in the fourth zone as shown in FIGS. 5A and 5B, it may be also shifted to negative so as to further improve the average wavefront aberration on an HDDVD. The case where the surface shape of the fourth zone is optimized in this way is described as a second embodiment of the present invention. FIG. 24A, FIG. 24B and FIG. 24C show the configuration of the optical system and the lens data. FIG. 16A, FIG. 16B, FIG. 17A and FIG. 17B show the wavefront aberration charts. FIG. 9A, FIG. 9B, FIG. 10A and FIG. 10B show the optical spot charts.

In the second embodiment also, the first zone is a common region which suitably focuses light on optical discs of both a Blu-ray Disc and an HDDVD disc, the second and fourth zones are HDDVD exclusive regions which suitably focus light on an HDDVD, and the third and fifth zones are Blu-ray exclusive regions which suitably focus light on a Blu-ray Disc.

The optical system of the second embodiment has the same configuration as that of the first embodiment except that the aberration correction plate 9 shown in FIG. 15A and FIG. 15B is replaced with an aberration correction plate 10. For an HDDVD shown in FIG. 16A and FIG. 16B, the surface shape of the fourth zone is designed so that the wavefront aberration in the fourth zone is not zero but −0.10λ. Because the wavefront aberration in the fourth zone is −0.10λ, it is yet closer to the wavefront aberration of −0.07 to −0.12λ in the second zone and the wavefront aberration of 0 to −0.39λ in the first zone compared with the first embodiment. Accordingly, in an optical spot on an HDDVD shown in FIG. 9A and FIG. 9B, a side lobe is improved to 1.0% relative to the center light intensity. On the other hand, for a Blu-ray Disc, the wavefront aberration in the fourth zone in FIG. 17A decreases by 0.1λ compared with that of FIG. 6A. A change of 0.1λ has substantially no effect because it is deviated by 8 to 15λ originally. This is shown in the optical spot of a Blu-ray Disc in FIG. 10A and FIG. 10B. A side lobe that occurs in the second embodiment is 2.1%, which is the same as that in the first embodiment.

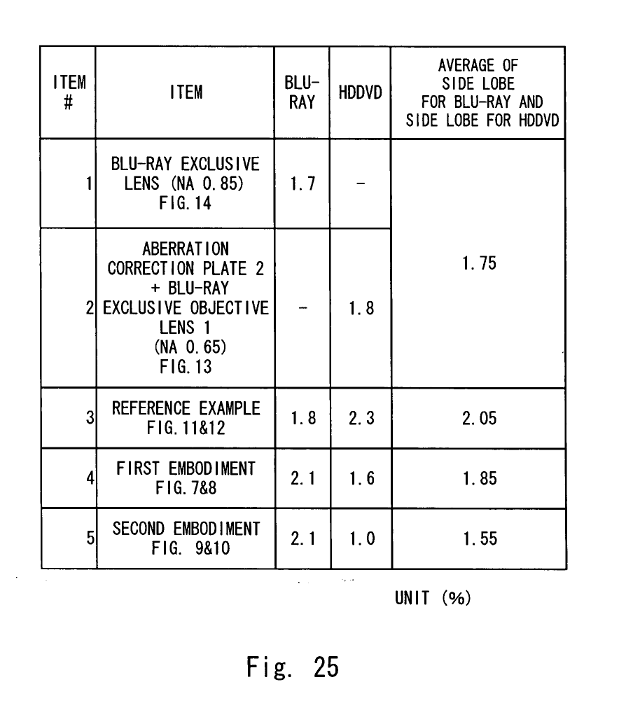

FIG. 25 shows a summary of side lobe values. The first and second embodiments achieve a side lobe of 2.1% or less for both a Blu-ray Disc and an HDDVD. In the second embodiment, a side lobe for an HDDVD is as low as 1.0%. A compatible lens for a Blu-ray Disc and an HDDVD ideally has the equal or better performance to an exclusive lens for each disc. A side lobe value of each exclusive lens is 1.75% on average of the item #1 and the item #2. Roughly, 2% or less is satisfactory. Preferably, it is 1.7% or less, which is better than an exclusive lens. Referring to the items #3, 4 and 5 in FIG. 25, an average side lobe of the reference example in the item #3 is 2.05%, which does not satisfy the target value. On the other hand, an average side lobe of the first embodiment is 1.85%, which satisfies the target value of 2% or less. Further, an average side lobe of the second embodiment is 1.55%, which satisfies a preferred value of 1.7% or less, that is better than the target value.

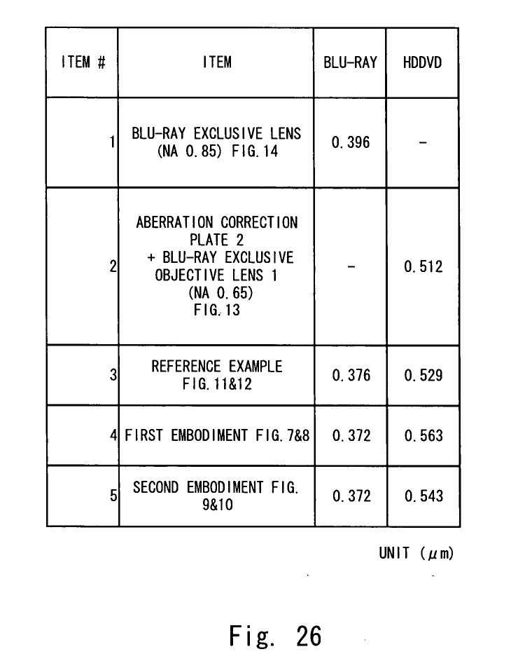

FIG. 26 is a summary of the spot diameter in which the relative light intensity with respect to the center is 13.5% or higher, that is, the spot diameter of 1/e². In both of the first and second embodiments, a spot diameter is small for a Blu-ray Disc and it is large for an HDDVD. If, for example, an aperture stop diameter is narrowed from φ2.4 mm to reduce NA of a Blu-ray Disc, and the outer radius of the fourth zone of the aberration correction plate is enlarged from 0.9178 mm to increase NA of an HDDVD, it is possible to obtain an optical spot diameter corresponding to NA=0.85 for a Blu-ray Disc and an optical spot diameter corresponding to NA=0.65 for an HDDVD.

In the first and second embodiments and the reference example, it is necessary to use only one aperture stop, which is an aperture stop for a Blu-ray Disc with NA=0.85, and there is no need to replace an aperture stop when using an HDDVD. This is significantly effective for configuring an optical pickup with a simple structure. Because the light which passes through a Blu-ray exclusive region with NA=0.65 to 0.85 becomes flare and does not contribute to an HDDVD as shown in FIG. 15A, an aperture stop for an HDDVD is not required.

Because NA is as high as 0.6 or above for both a Blu-ray Disc and an HDDVD, it is easy to allow the unnecessary light to become flare which does not contribute to an optical spot. Further, the wavelength of light is 405 nm, which is 0.64 to 0.51 times the wavelength of light for a DVD and a CD, 635 to 660 nm and 780 to 790 nm, respectively, which have been widely used. When producing ray aberration so that unnecessary light becomes flare, the number of times the ray aberration amount corresponds to the wavelength is inversely proportional to the wavelength. Thus, the aberration amount of many times larger than the wavelength is easy to be obtained in Blu-ray light having a shorter wavelength than DVD or CD light, and therefore unnecessary light is easy to become flare which does not contribute to an optical spot. Accordingly, having a short wavelength of 405 nm and a large NA of 0.6 or above is advantageous in terms of easiness of becoming flare which does not contribute to an optical spot.

Further, because incoming light from an infinite distance, such as parallel light through a collimator lens or the like, can be used for both a Blu-ray disc and an HDDVD, there is no need to use a switching mechanism for changing a distance of incoming light, and the position of a laser and a photo detector can be standardized. Further, it eliminates the deterioration of aberration which is caused by that incoming light is obliquely incident when an objective lens optical system is shifted and the position of image formation has some image height.

The number of zones may be more than five so as to obtain even more suitable optical spot shape. In the embodiments of the present invention, five or more a plurality of zones are formed on the aberration correction plate. As a material of an objective lens of NA 0.85, glass, which is less subject to change in size or refractive index due to temperature than plastic, is often used for the stability of performance upon temperature change. Although the plurality of zones may be formed on an objective lens, it is difficult for a manufacturing technique to form a plurality of zones with steps on a glass lens. Plastic is easier to form a plurality of zones thereon. Accordingly, it is preferred to form a plurality of zones on a plastic aberration correction plate and prepare a glass objective lens having a single aspherical surface shape without any step. The objective lens and the aberration correction plate of the present invention are preferably mounted on the same actuator so as to prevent the decentering of both elements upon shifting a lens.

As described in the foregoing, the present embodiments have advantages of focusing a light beam on information recording surfaces of optical discs with different thickness with a low side lobe value without the need for an aperture stop switching mechanism or a lens switching mechanism.

1. An objective lens optical system for focusing a light beam on each information recording surface on at least two different thicknesses of transparent substrates in two or more kinds of optical information recording media, wherein
at least one surface of two surfaces constituting an optical element is radially sectioned into five or more zones,
at least one zone of the five or more zones is a common zone for focusing the light beam on each information recording surface of the two or more kinds of optical information recording media, and
at least four zones of the five or more zones are exclusive zones for focusing the light beam on an information recording surface of either one optical information recording medium of the two or more kinds of optical information recording media.

2. The objective lens optical system according to claim 1, comprising: an objective lens; and an aberration correction plate.

3. The objective lens optical system according to claim 2, wherein the objective lens is made of glass, and the aberration correction plate is made of plastic.

4. The objective lens optical system according to claim 1, wherein the light beam includes a light beam with a wavelength of about 405 nm.

5. The objective lens optical system according to claim 1, wherein the light beam focused on the information recording surface includes a light beam of NA 0.8 to NA 0.9.

6. The objective lens optical system according to claim 1, wherein the light beam focused on the information recording surface on at least two different thicknesses of transparent substrates is NA 0.60 or larger.

7. The objective lens optical system according to claim 1, wherein the light beam focused on the information recording surface on at least two different thicknesses of transparent substrates includes a light beam of NA 0.8 to NA 0.9 and a light beam of NA 0.6 to NA 0.7.

8. The objective lens optical system according to claim 1, wherein an average of a side lobe in each optical recording medium on an optical spot of the light beam focused on the information recording surface on the optical information recording media is 2% or smaller.

9. The objective lens optical system according to claim 8, wherein an average of a side lobe in each optical recording medium is 1.7% or smaller.

10. The objective lens optical system according to claim 1, wherein both of a light beam passing through the exclusive zone and a light beam passing through the common zone are focused on an information recording surface of a corresponding optical information recording medium with wavefront aberration of 0 or larger or wavefront aberration of 0 or smaller.

11. The objective lens optical system according to claim 1, wherein both of a light beam passing through the exclusive zone and a light beam passing through the common zone are focused on an information recording surface of a corresponding optical information recording medium with wavefront aberration of 0 to 0.4λ or wavefront aberration of −0.4λ to 0.

12. An objective lens optical system for focusing a light beam with a wavelength λ on each information recording surface on a first optical information recording medium having a transparent substrate with a thickness t₁ and a second optical information recording medium having a transparent substrate with a thickness t₂, the objective lens optical system including an objective lens and an aberration correction plate, wherein
the objective lens is configured to focus the light beam on an information recording surface on the transparent substrate with the thickness t₁ of the first optical information recording medium with aberration being corrected suitably,
at least one surface of the aberration correction plate is radially sectioned into five or more zones,
at least one zone of the five or more zones is a common zone for focusing the light beam on each information recording surfaces of both the first optical information recording medium and the second optical information recording medium, and
at least four zones of the five or more zones are exclusive zones for focusing the light beam on an information recording surface of either one optical information recording medium of the first optical information recording medium and the second optical information recording medium.

13. The objective lens optical system according to claim 12, wherein both of a light beam passing through the exclusive zone and a light beam passing through the common zone are focused on an information recording surface of a corresponding optical information recording medium with wavefront aberration of 0 to 0.4λ or wavefront aberration of −0.4λ to 0.

14. An optical pickup optical system for focusing a light beam on each information recording surface on at least two different thicknesses of transparent substrates in two or more kinds of optical information recording media, wherein
at least one surface of two surfaces constituting an optical element is radially sectioned into five or more zones,
at least one zone of the five or more zones is a common zone for focusing the light beam on each information recording surface of the two or more kinds of optical information recording media, and
at least four zones of the five or more zones are exclusive zones for focusing the light beam on an information recording surface of either one optical information recording medium of the two or more kinds of optical information recording media.
